(19) United States
(12) Patent Application Publication
(10) Pub. No.: US 2008/0034078 A1
(43) Pub. Date: Feb. 7, 2008

(54) Presence information management system, presence server device, gateway device and client device

(75) Inventors: Takeshi Sano, Kawasaki (JP); Masaaki Takase, Kawasaki (JP); Mitsuaki Kakemizu, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/641,047

(22) Filed: Dec. 19, 2006

(30) Foreign Application Priority Data
Aug. 1, 2006 (JP) JP2006-209438

(51) Int. Cl. G06F 15/173

(52) U.S. Cl. 709/223

(57) ABSTRACT

The present invention provides a presence information management system, a presence server device, a gateway device and a client device, which notify of presence information in realtime while restraining communications traffic. The presence server device managing presence information of a plurality of presentities, comprises a delegating unit sending delegating notification of presence information management function related to at least one of the plurality of presentities, to another device becoming a delegatee of the presence information management function. The gateway device comprises a managing unit managing presence information of a presentity, and a control unit performing control so that, when receiving the delegating notification of the presence information management function about at least one of the plurality of presentities from a presence server, the managing unit is executed with respect to the function-delegated presentity.

### BACKGROUND OF THE INVENTION

1. Field of the Invention

The present invention relates to a presence information management system, a presence server device, a gateway device and a client device.

2. Description of the Related Art

A presence service is given as a communication service provided on a network. The presence service is a service for providing a multiplicity of clients connected to the network with a connecting state, an operation status, etc which will hereinafter be referred to also as presence information) of the client becoming a desired communication partner device. The presence service is actualized based on, e.g., SIP (Session Initiation Protocol).

A presence information management system for providing the multiplicity of clients with this type of presence service will be explained with reference to FIG. 21. FIG. 21 is a diagram showing an example of a system architecture of a conventional presence information management system. In the conventional presence information management system in the example in FIG. 21, a presence server 500 provides a client 501 with presence information of a client 502. The client 501 requesting the presence information is called a watcher, while the client 502 becoming an information source device is called a presentity.

Each watcher 501, when desiring to refer to the presence information of the client 502, sends a presence disclosure request (SUBSCRIBE) showing this purport to the presence server 500. The presence server 500 acquires, when receiving this SUBSCRIBE, the presence information of the presentity 502, and gives presence notification (NOTIFY) to the watcher 501. Further, the presentity 502, when detecting that a self operation status etc is changed, sends presence changing notification to the presence server 500. The presence server 500, when receiving this presence changing notification, gives presence notification (NOTIFY) to each of the watchers 501 requesting the presence information.

In the system architecture shown in FIG. 21, however, in the case of providing the presence service broadly to the multiplicity of clients 501 and 502, there arises a problem of causing an increase in a communication quantity on a core network 515 that connects a site (subnetwork) 511 where the presence server 500 is disposed to sites 512, 513 where the clients 501, 502 are disposed.

For solving this problem, there is a communication system including a default presence server for managing the presence information as a whole, and proxy presence servers disposed on the unit of a predetermined subnetwork and managing the presence information of the clients in the respective subnetworks. FIG. 22 is a diagram showing a communication sequence of the presence service in this type of communication system. In this communication system, the default presence server organizes the plurality of clients into groups on the unit of the subnetwork, and the presence information of each client is acquired from each proxy presence server on a group-by-group basis. In a case where a certain client acquires the information of the plurality of clients from the default presence server, the presence information is provided on the unit of the group to which each client belongs.

This type of method enables reduction of the traffic size on the core network that connects default presence server to the clients.

It is to be noted that the technology disclosed in the following document is given as the conventional art related to the invention of the present application. The conventional art document is “Japanese Unexamined Patent Publication No. 2004-531798.”

In the conventional method described above, however, even when the watcher and the presentity exist in the same subnetwork, the communications are performed between the watcher and the proxy presence server and between the proxy presence server and the default presence server, and hence the communications performed across the core network in reciprocation (the communications between the proxy presence server and the default presence server) get inefficient.

Further, this type of conventional method, since the watcher needs to transmit a presence information acquiring request, can not be applied to a service for notifying of the presence information of the presentity in realtime.

### SUMMARY OF THE INVENTION

It is an object of the present invention to provide a presence information management system, a presence server device, a gateway device and a client device, which notify of the presence information in realtime while restraining the communications traffic.

The present invention adopts the following configurations in order to solve the problems. Namely, the present invention relates to a presence server device managing presence information of a plurality of presentities, comprising a delegating unit sending delegating notification of presence information management function related to at least one of the plurality of presentities, to another device becoming a delegatee of the presence information management function.

Further, the present invention relates to a gateway device comprising a managing unit managing presence information of a presentity, and a control unit performing control so that, when receiving the delegating notification of the presence information management function about at least one of the plurality of presentities from the above-mentioned presence server that manages the presence information of the plurality of presentities, the managing unit is executed with respect to the function-delegated presentity for which the presence information management function is delegated.

In the present invention, the presence information management function possessed by the presence server device is delegated, for every presentity, from the presence server device to another device (e.g., the gateway device). Then, the another device manages the presence information of the target presentity of the delegating notification.

Herein, the presence information connotes information about, e.g., a connection state, an operation status, etc of each client. Further, the presence information management function is exemplified by, as described by way of the conventional art, a function of acquiring the presence information from the presentity, a function of notifying (NOTIFY) the watcher, in the case of receiving presence information changing notification from the presentity, of the acquired presence information thereof, and so on.

Therefore, according to the present invention, for instance, if the watchers requesting the presence information of the predetermined presentity exist concentratedly in a certain site, the management of the presence information of this presentity can be delegated to the gateway device etc in this site. With this scheme, it is possible to reduce the communication volume flowing across the core network between this site and the server site where the presence server exists.

Moreover, the presence information management function includes, in the case of receiving the presence information changing notification from the presentity, a function of NOTIFYing the watcher of this received presence information, and hence, according to the present invention, the watcher can be notified of the presence information in realtime.

Still further, the presence server device according to the present invention may further comprise a retaining unit retaining, with respect to every presentity, information about a watcher requesting presence disclosure and a delegating condition, and a determining unit determining, based on the information retained by the retaining unit, the presentity for which the presence information management function is delegated and another device becoming the delegatee.

With this configuration, the presence server device can determine the proper device becoming the delegatee and the presentity for which the function should be delegated.

Yet further, the presence server device according to the present invention may further comprise a delegatee retaining unit retaining the information about the presentity for which the presence information management function is delegated and the information about the another device becoming the delegatee, and a transmitting unit transmitting, when receiving a presence disclosure request related to the presentity for which the presence information management function is delegated, the information about the another device becoming the delegatee to the watcher that sends the presence disclosure request based on the information retained by the delegatee retaining unit.

With this configuration, even the watcher that does not know that the presence information management function has been delegated, can send the presence disclosure request again to the another delegatee device on the basis of the information about the another delegatee device, which is transmitted from the transmitting unit.

Furthermore, the gateway device according to the present invention may further comprise a notifying unit notifying, when receiving the delegating notification of the presence information management function, the function-delegated presentity and a watcher requesting the presence disclosure with respect to the function-delegated presentity, of a purport that the presence information management function is delegated to the gateway device itself.

Hereby, the present invention embraces a client (presentity) device providing presence information of the client device itself, comprising a change notifying unit transmitting, when receiving notification purporting that a server function of managing the presence information provided from the client itself is delegated, presence information changing notification to a device to which the server function is delegated.

Similarly, the present invention embraces a client (watcher) device provided with presence information of another client device, comprising a notification receiving unit receiving, when receiving notification purporting that a server function of managing presence information of a client device that is requested by a self-device is delegated, presence notification of the requester client device from a delegatee device to which the server function is delegated.

Moreover, the present invention may also be a presence information management system comprising the presence server device, the gateway device and the client device.

As another aspect, the present invention is a presence information management system comprising a first presence server and a second presence server that manage presence information of a presentity so as not to be overlapped with each other, the presentity including request a transmitting unit transmitting, when starting providing presence information of the presentity itself, a registration request for using the presence service to the second presence server that should manage the presence information of the presentity itself, the second presence server including a managing unit starting, when receiving the registration request for using the presence service, management of the presence information of the presentity becoming a sender of the request; and a start notifying unit notifying the first presence server that the second presence server itself starts the management of the presence information of the presentity, the first presence server including a retaining unit retaining information showing that the second presence server starts managing the presence information of the presentity.

According to the presence information management system in this aspect, the same effect as the above can be exhibited without having the function of delegating the presence information management function from the presence server to another device by previously including the device such as the second presence server. Namely, it is feasible to reduce the communications traffic flowing across the core network between the site where the client managed by the second presence server is located and the site where the first presence server exists, and further to actualize the realtime notification of the presence information.

As still another aspect, the present invention relates to a gateway device comprising a request receiving unit receiving a plurality of presence disclosure requests with respect to the same presentity from a plurality of watchers, a transferring unit transferring, to a presence server, at least one of the plurality of presence disclosure requests received by the request receiving unit as a presence disclosure request from a single virtual watcher associated with the plurality of watchers, and a transmitting unit transmitting, when receiving presence information changing notification to the single virtual watcher, the received presence information changing notification respectively to the plurality of watchers associated with the virtual watcher.

Based on this aspect, the present invention embraces a presence server device comprising receiving unit receiving a presence disclosure request from a virtual watcher with respect to a predetermined presentity, and a transmitting unit transmitting, when receiving presence information changing notification from the predetermined presentity, the received presence information changing notification to the virtual watcher.

According to the gateway device and the presence server device in this aspect, even in such a case that there exist the plurality of watchers requesting the presence information of a certain presentity, a presence service related message between the certain presentity and the single watcher (virtual watcher) is merely transferred between the gateway device and the presence server device.

With this scheme, it is possible to decrease the communications traffic flowing across the core network between the site where the gateway device exists and the site where the presence server exists.

It should be noted that the present invention may be a method of making a computer actualize any of the functions described above. Further, the present invention may also be a program that gets any of the functions actualized. Still further, the present invention may also be a readable-by-computer storage medium storing such a program.

According to the present invention, it is possible to provide the presence information management system, the presence server device, the gateway device and the client device, which notify of the presence information in realtime while restraining the communications traffic.

### BRIEF DESCRIPTION OF THE DRAWINGS

FIG. 1 is a diagram showing a system architecture (network architecture) of a presence information management system in a first embodiment;

FIG. 2 is a diagram showing a functional configuration of a default server in the first embodiment;

FIG. 3 is a diagram showing a presence information table within a presence information management database;

FIG. 4 is a diagram showing an in-site presence server information table within an in-site presence server information management database;

FIG. 5 is a diagram showing a functional configuration of an in-site presence server in the first embodiment;

FIG. 6 is a diagram showing a delegator presence server information table within a delegator presence server information management database;

FIG. 7 is a diagram showing a functional configuration of a client in the first embodiment;

FIG. 8 is a diagram showing a presentity information table within a presentity information management database;

FIG. 9 is a diagram showing an operational example when delegating a presence server function to an in-site server from a default server;

FIG. 10 is a diagram showing an operational example when delegating the presence server function from the in-site server to the default server;

FIG. 11A is a diagram showing an operational example when delegating the presence server function to the in-site server from the in-site server;

FIG. 11B is a diagram showing an operational example when delegating the presence server function to the in-site server from the in-site server;

FIG. 12 is a diagram showing an operational example when redirecting a SUBSCRIBE in the default presence server;

FIG. 13 is a diagram showing a functional configuration of the default server in a second embodiment;

FIG. 14 is a diagram showing a presence information table within a presence information management database in the second embodiment;

FIG. 15 is a diagram showing a functional configuration of the in-site presence server in the second embodiment;

FIG. 16 is a diagram showing an operational example when making a registration request for using the presence service;

FIG. 17 is a diagram showing an operational example when redirecting the SUBSCRIBE in the second embodiment

FIG. 18 is a diagram showing a functional configuration of the in-site presence server in a third embodiment;

FIG. 19 is a diagram showing a watcher information table within a watcher information management database;

FIG. 20A is a diagram showing an operational example when making the SUBSCRIBE in the presence information management system in the third embodiment;

FIG. 20B is a diagram showing an operational example when making the SUBSCRIBE in the presence information management system in the third embodiment;

FIG. 20C is a diagram showing an operational example when making the SUBSCRIBE in the presence information management system in the third embodiment;

FIG. 21 is a diagram showing an example of a system architecture of a conventional presence information management system; and

FIG. 22 is a diagram showing a communication sequence of a conventional presence service.

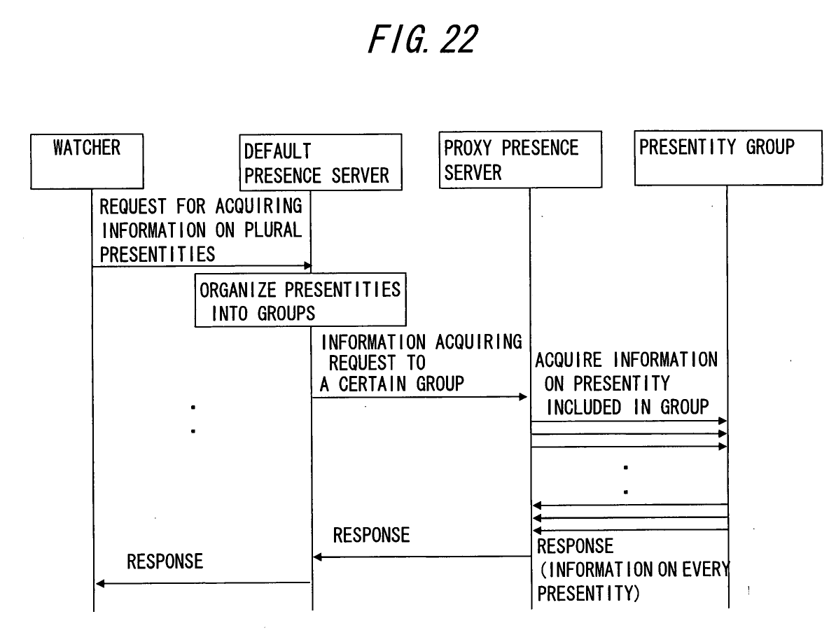

### DESCRIPTION OF THE PREFERRED EMBODIMENTS

A presence information management system in each of embodiments of the present invention will hereinafter be described with reference to the drawings. It should be noted that configurations in the following embodiments are exemplifications, and the present invention is not limited to the configurations in the embodiments.

### First Embodiment

A presence information management system in a first embodiment of the present invention will hereinafter be explained.

[System Architecture]

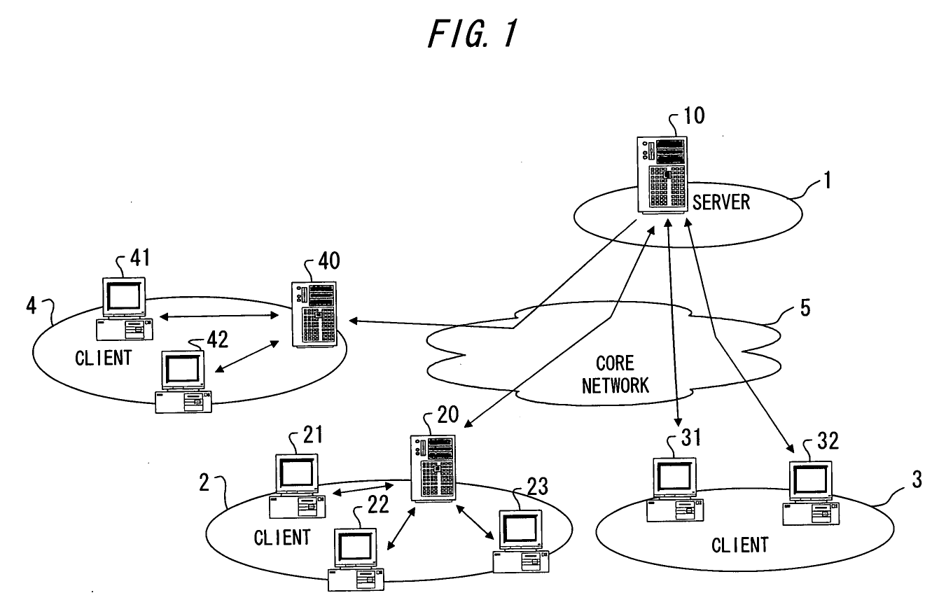

A system architecture of the presence information management system in the first embodiment will be described with reference to FIG. 1. FIG. 1 is a view showing the system architecture (network architecture) of the presence information management system in the first embodiment.

The presence information management system in the first embodiment is configured by connecting a server site 1 and client sites 2, 3 and 4 to each other via a core network 5. For example, these sites are connected based on IP (Internet Protocol). A default presence server device (which will hereinafter be referred to as a default server or a default presence server) 10 is connected to the server site 1. An in-site presence server device (which will hereinafter be referred to as an in-site server or an in-site presence server) 20 and client devices (which will hereinafter be simply termed clients) 21, 22, 23 are connected to the client site 2, clients 31, 32 are connected to the client site 3, and an in-site server 40 and clients 41, 42 are connected to the client site 4. The default presence server 10 corresponds to a presence server device according to the present invention. The in-site servers 20, 40 correspond to gateway devices according to the present invention. The client 21 etc corresponds to a client device according to the present invention.

Each client can be provided with a presence service by accessing the device (initially, the default server 10) having a presence server function. Each of the clients illustrated in FIG. 1 has a function of being provided with the presence service and is a device eligible both for the watcher and for the presentity.

[Configuration of Device]

Configurations of the devices such as the default server 10, the in-site presence servers 20, 40 and the clients 21, 22, 23, 31, 32, 41, 42 configuring the presence information management system in the first embodiment, will respectively explained.

<Default Presence Server>

The default presence server 10 is a computer including a CPU (Central Processing Unit), a memory, an input/output interface, etc, wherein the CPU executes a control program stored in the memory such as a hard disc, thereby actualizing the presence server function that will be described as follows. Note that the default presence server 10 may also be a server having a general server function other than this presence server function.

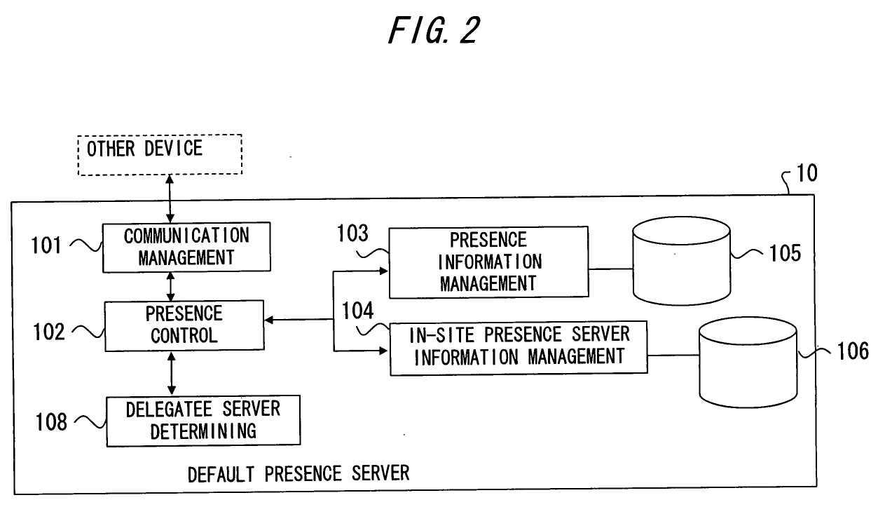

The default server 10 is a management server for providing each client with the presence service, and has a functional configuration shown in FIG. 2 as the presence server function. FIG. 2 is a block diagram showing the functional configuration of the default server 10 in the first embodiment. The default server 10 has a communication management unit 101 (corresponding to transmitting unit according to the present invention), a presence control unit 102 (corresponding to delegating unit and determining unit according to the present invention), a presence information management unit 103 (corresponding to retaining unit according to the present invention), an in-site presence server information management unit 104 (corresponding to delegatee retaining unit according to the present invention), and a delegatee server determining unit 108 (corresponding to determining unit according to the present invention). These functions will be explained, respectively.

<<Communication Management Unit>>

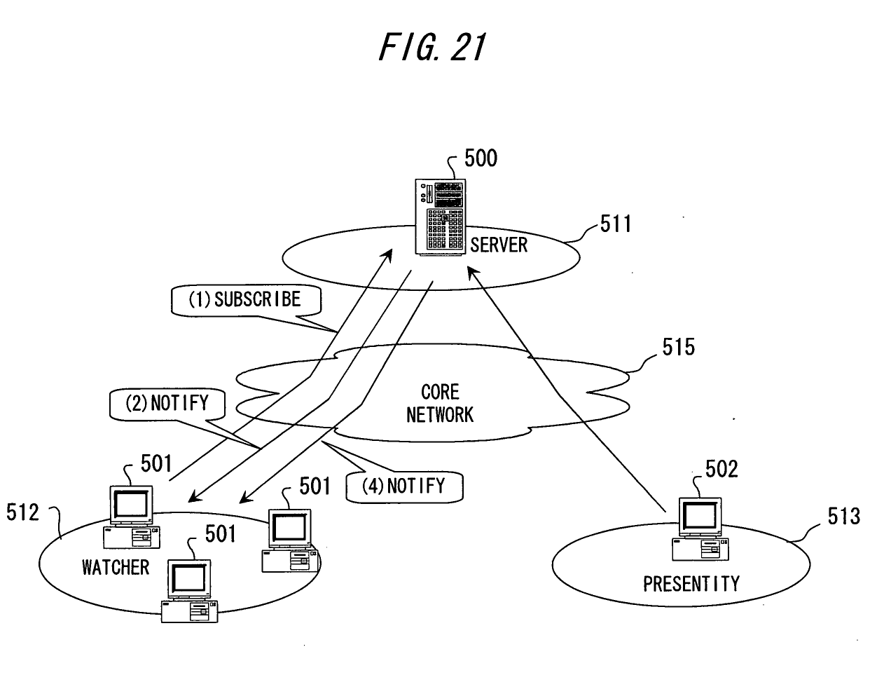

The communication management unit 101 receives self-addressed messages from other devices such as the clients, and sends messages addressed to other devices. The communication management unit 101, for instance, as shown in FIG. 21, receives a presence disclosure request (SUBSCRIBE) sent from the watcher and also receives a presence change notification sent from the presentity. Further, the communication management unit 101 transmits presence notification (NOTIFY) to the watcher.

The communication management unit 101, when receiving the messages, transfers a presence service related message in the received messages to the presence control unit 102. Moreover, the communication management unit 101, when sending the messages, receives the presence service related message from the presence control unit 102, and sends this message.

<<Presence Control Unit>>

The presence control unit 102, in order to actualize the presence server function in the case of receiving the presence service related message from the communication management unit 101, controls the presence information management unit 103, the in-site presence server information management unit 104 and the delegatee server determining unit 108. The functions actualized by the presence control unit 102 are a general presence server function (function 1), a function (function 2) of delegating the presence serve function to the in-site presence server per presentity, a function (function 3) of notifying, in the case of receiving the SUBSCRIBE to the presentity for which the presence server function is delegated, a sender that the SUBSCRIBE be redirected to the in-site presence server that manages this presentity, and a presence server change notifying function (function 4) in a case where the presence server function delegated to the in-site presence server is transferred back.

As the (function 1), the presence control unit 102, when receiving the SUBSCRIBE from the watcher, acquires, from this message, information about the watcher defined as the sender of the SUBSCRIBE and information about the SUBSCRIBE target presentity, and transfers these acquired items of information to the presence information management unit 103. On the other hand, the presence control unit 102 instructs the communication management unit 101 to notify (NOTIFY) the watcher, defined as the sender of the SUBSCRIBE, of the presence information about the SUBSCRIBE target presentity. Further, the presence control unit 102, upon receiving the presence change notification from the presentity, instructs the presence information management unit 103 to retain this presence information, and, along with this, instructs the communication management unit 101 to transmit the changed presence information to the watcher related to this presentity. The presence control unit 102, for actualizing this (function 1), instructs the presence information management unit 103 to retain and manage a watcher count, location information, etc about the respective presensities.

The presence control unit 102, for actualizing the (function 2), controls the in-site presence information management unit 104 and the delegatee server determining unit 108. The case that the presence server function in the (function 2) is delegated, includes a case in which the delegatee server determining unit 108 within the self-device determines to delegate the function to the in-site presence server and a case in which the in-site presence server, to which the presence server function is delegated, determines to further delegate the presence server function to the in-site presence server of another site.

The presence control unit 102, when the delegatee server determining unit 108 within the self-device determines to delegate the presence server function, instructs the communication management unit 101 to transmit the presence server function delegating notification to the in-site presence server of the delegatee. At this time, the presence control unit 102 acquires, from the presence information management unit 103, the information on the target presentity and the information on all of the watchers of this presentity in order to get these items of information contained in the presence server function delegating notification. Along with this, the presence control unit 102 instructs the in-site presence server information management unit 104 to manage a relationship etc between each presentity for which the presence server function has been delegated and an address of the in-site presence server of the delegatee.

The presence control unit 102, when the in-site server, to which the presence server function is delegated, determines to further delegate the presence server function to the in-site server of the another site and when receiving the presence server function delegating notification from this in-site server, instructs the communication management unit 101 to transfer the presence server function delegating notification to the in-site server of the delegatee. At this time, the presence control unit 102 instructs the presence information management unit 103 to retain the information on the presentity and the information on all of the watchers of this presentity, which are contained in the presence server function delegating notification. Along with this, the presence control unit 102 instructs the in-site presence server information management unit 104 to manage the relationship etc between each presentity for which the presence server function has been delegated and the address of the in-site presence server of the delegatee.

The presence control unit 102, in order to actualize the (function 3), in the case of receiving the SUBSCRIBE to the presentity for which the presence server function is delegated, instructs the communication management unit 101 to notify the sender watcher, of the SUBSCRIBE, of the information on the in-site presence server of the delegatee. At this time, the presence control unit 102 obtains, from the in-site presence server information control unit 104, the information about whether the presence server function related to the target presentity is delegated or not and the information about a URI (Uniform Resources Identifier) of the in-site presence server of the delegatee.

As the (function 4), the presence control unit 102, when receiving from the communication management unit 101 the presence server function delegating notification purporting that the presence server function delegated to the in-site presence server is transferred back, instructs the communication management unit 101 to send presence server change notification to the presentity for which the presence server function has been transferred back and to all of the watchers requesting the presence information of this presentity. At this time, pieces of information contained in the presence server function delegating notification are utilized as the information about the presentity for which the present invention function is delegated and the information about all of the watchers related to this presentity.

<<Presence Information Management Unit>>

The presence information management unit 103 manages the presence information about the respective presentities and the information about the watchers sending the SUBSCRIBE, which are transferred from the presence control unit 102 as described above. These items of information are retained in a presence information management database (DB) 105.

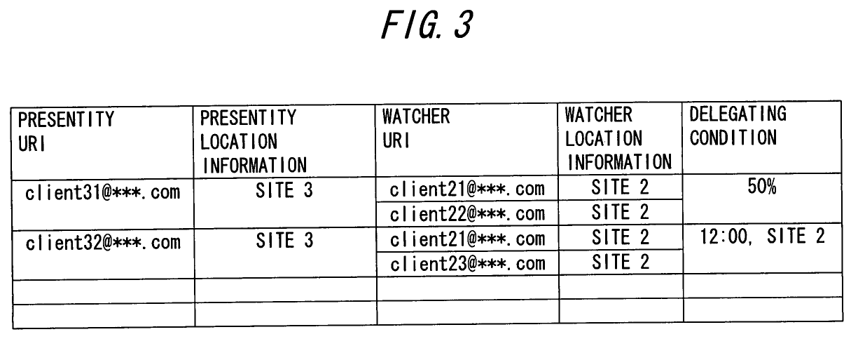

FIG. 3 is a diagram showing a presence information table in the presence information management DB 105. The presence information table retains items of information about the presentities and about the watchers sending the SUBSCRIBE targeting at the presentities. To be specific, the presence information table retains a presentity URI (Uniform Resource Identifier), presentity location information, a watcher URI, watcher location information and a delegating condition.

The “delegating condition” field stores a condition for determining the delegation of the presence server function. If a behavior pattern of the watcher acquiring the presence information of a certain presentity is previously recognized, a condition corresponding to this behavior pattern is set as the delegating condition. For example, if 50% or more of the watchers with respect to a certain presentity concentrate on the same site in a predetermined time zone, pieces of information on this predetermined time zone and on the site are set as the delegating conditions. This delegating condition may involve using a default value retained in the memory etc of the default server 10, and may also be inputted from an input device etc.

According to the example shown in FIG. 3, the client 31 (of which URI is [client31@***.com], and the location information is [site 3]) is registered as the presentity, and the client 21 (of which URI is [client21@***.com], and the location information is [site 2]) and the client 22 (of which URI is [client22@***.com], and the location information is [site 2]) are respectively registered as the watchers requesting the presence information of the client 31. Then, if a certain site occupies 50% or more of all of the watchers with respect to this presentity, such a delegating condition is set that the presence server function is delegated to the in-site presence server in this site.

Moreover, the client 32 (client32@***.com, site 3) is registered as the presentity, and the client 21 (client21@***.com, site 2) and the client 23 (client23@***.com, site 2) are respectively registered as the watchers requesting the presence information of the client 32. Then, in a relationship between this presentity and the watchers, such a delegating condition is set that the presence server function is delegated to the in-site presence server in the site 2 at twelve o'clock.

<<In-Site Presence Server Information Management Unit>>

The in-site presence server information management unit 104, with respect to the presentity for which the presence server function is delegated, manages the information about this presentity and about the in-site presence server of the delegatee. These items of information are retained in the in-site presence server information management database (DB) 106.

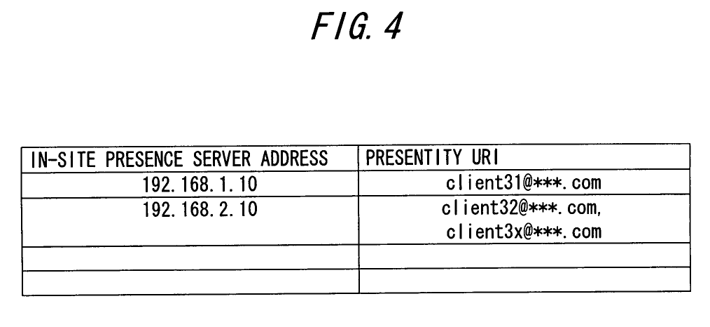

FIG. 4 is a diagram showing an in-site presence server information table in the in-site presence server information management DB 106. The in-site presence server information table retains, with respect to each presentity, the information about the in-site presence server of the delegatee to which the presence server function is delegated. To be specific, the in-site presence server information table retains a presentity URI and an in-site presence server address.

<<Delegatee Server Determining Unit>>

The delegatee server determining unit 108 determines, based on the information within a presence information management DB 105 managed by the presence information management unit 103, the in-site presence server to which the presence server function is delegated. Specifically, the delegatee server determining unit 108 determines as to whether the presence server function related to each presentity is delegated or not and determines the delegatee site by judging the delegating condition in the presence information table, and specifies, based on the address information of every in-site presence server that is separately previously retained, the in-site presence server 20 in the site determined as the delegatee site.

The delegatee server determining unit 108, in the case of determining the delegation of the presence server function, notifies the presence control unit 102 of this purport and of the address information of the in-site presence server as the delegatee of this function. The presence control unit 102 sends these items of information to the in-site presence server information management unit 104 so as to retain the information in the in-site presence server information table.

<<In-Site Presence Server>>

The in-site presence servers 20 and 40, when receiving the presence server function delegating notification from the default server 10, operate as management servers for providing the respective clients with the presence service related to the target presentity. The present invention does not limit the operations of the in-site presence servers 20 and 40 before the presence server function is delegated. Hence, the in-site presence servers 20 and 40 before the presence server function is delegated may also be configured to operate as general gateway devices and to operate as the clients. Note that the in-site presence servers 20 and 40 are the devices each having the same function, and therefore the following discussion shall give the description with their numerals and symbols omitted except a case of requiring a distinction therebetween.

The in-site presence server is the computer including the CPU, the memory, the input/output interface, etc, wherein the CPU executes the control program stored in the memory such as the hard disc, thereby actualizing the in-site presence server function that will be described as follows. Note that the in-site presence server may also be a server having functions other than the functions that will hereinafter be described.

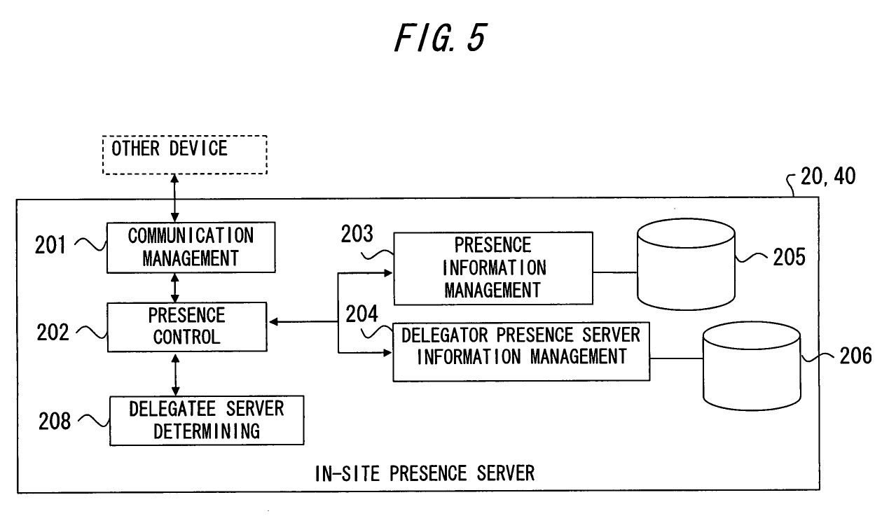

The in-site presence server has a functional configuration shown in FIG. 5, as an in-site presence server function. FIG. 5 is a block diagram showing the functional configuration of the in-site presence server in the first embodiment. The in-site presence server has a communication management unit 201 (corresponding to notifying unit according to the present invention), a presence control unit 202 (corresponding to managing unit and control unit according to the present invention), a presence information management unit 203 (corresponding to managing unit according to the present invention), a delegator presence server information management unit 204, a delegatee server determining unit 208 and so on. These functional units, when the communication management unit 201 receives the presence server function delegating notification from the default server 10, start operating under the control of the presence control unit 202. These functions will be explained, respectively.

<<Communication Management Unit>>

The communication management unit 201, when receiving the presence server function delegating notification from the default server 10, sends this notification to the presence control unit 202. The communication management unit 201 performs, after receiving this notification, the same operation as the communication management unit 101 of the default server 10 with regard to a message related to the presentity for which the presence server function is delegated. The communication management unit 201 may also conduct the operation before receiving the presence server function delegating notification and the operation in the case of receiving a message related to the presentity for which the presence server function is not delegated in a way that performs the operations as a simple gateway.

<<Presence Control Unit>>

The presence control unit 202, after receiving the presence server function delegating notification from the communication management unit 201, in order to actualize the in-site presence server function with respect to the target presentity, controls the presence information management unit 203, the delegator presence server information management unit 204 and the delegatee server determining unit 208. The functions actualized by the presence control unit 202 are a general presence server function (function 1), a function (function 2) of delegating the presence server function to the default presence server or to the in-site presence server of another site for each presentity, and a presence server change notifying function (function 3) in the case of receiving the delegation of the presence server function.

As the (function 1), the presence control unit 202, when receiving the SUBSCRIBE from the watcher, transfers, to the presence information management unit 203, the information on the sender watcher and the information on the target presentity of the SUBSCRIBE. The case of receiving the SUBSCRIBE from the watcher includes a case of receiving the SUBSCRIBE directly from the watcher within the same site and a case in which the SUBSCRIBE is transmitted from the watcher in another site. On the other hand, the presence control unit 202 instructs the communication management unit 201 to transmit (NOTIFY), to the sender watcher, the presence information of the SUBSCRIBE target presentity.

Further, the presence control unit 202, when receiving the presence changing notification from the presentity, instructs the presence information management unit 203 to retain the presence information, and, along with this, instructs the communication management unit 201 to notify (NOTIFY) the watcher related to this presentity, of the changed presence information. The presence control unit 202, for actualizing this (function 1), instructs the presence information management unit 203 to retain and to manage a watcher count, location information, etc with respect to each presentity.

The presence control unit 202, for actualizing the (function 2), controls the delegator presence server information management unit 204 and the delegatee server determining unit 208. The presence control unit 202, when the delegatee server determining unit 208 determines to delegate the presence server function to the in-site presence server of another site, receives the information about the in-site presence server of the delegatee from the delegatee server determining unit 208. Further, the presence control unit 202 acquires information on a delegator default server from the delegator presence server information management unit 204 with respect to the presentity for which the delegation of the presence server function is determined. With this acquisition, the presence control unit 202 instructs the communication management unit 201 to send, to the delegator default server, the presence server function delegating notification containing the information about the in-site presence server of the delegatee, the information about the target presentity and the information about all of the watchers of this presentity.

Moreover, the presence control unit 202, when the delegatee server determining unit 208 determines a default server as a delegatee, instructs the communication management unit 201 to send the presence server function delegating notification to this default server. At this time, the presence control unit 202 controls the communication management unit 201 and the presence information management unit 203 to get the information about the target presentity and the information about all of the watchers of this presentity contained in the presence server function delegating notification.

As the (function 3), the presence control unit 202, when receiving the presence server function delegating notification from the communication management unit 201, sends information on this sender default server to the delegator presence server information management unit 204, and instructs the communication management unit 201 to further transmit a response to this notification to the default server. Furthermore, the presence control unit 202 instructs the communication management unit 201 to send the presence server changing notification to the presentity for which the presence server function is delegated and to all of the watchers requesting the presence information of this presentity. At this time, pieces of information contained in the presence server function delegating notification are utilized as the information about the presentity for which the present invention function is delegated and the information about all of the watchers related to this presentity.

<<Presence Information Management Unit>>

The presence information management unit 203 manages the presence information about each presentity and the information about the watcher making the SUBSCRIBE, which are transferred from the presence control unit 202 as described above. These items of information are retained in a presence information management database (DB) 205. Functions of the presence information management unit 203 and of the presence information management DB 205 are the same as those of the presence information management unit 103 and the presence information management DB 105 of the default server 10, and hence their explanations are omitted.

<<Delagator Presence Server Information Management Unit>>

The delegator presence server information management unit 204 manages the information on the default server as the delegator of the presence server function. Even in the case of delegating the function to the in-site server from the in-site server, the default server relaying this delegation becomes the delegator presence server. The information about this delegator presence server is retained in a delegator presence server information management database (DB) 206.

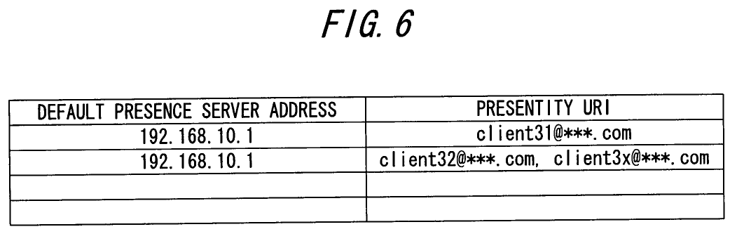

FIG. 6 is a diagram showing a delegator presence server information table within the delegator presence server information management DB 206. The delegator presence server information table retains, with respect to every presentity, the information about the delegator default presence server that delegates the presence server function of the presentity. To be specific, the delegator presence server information table retains a default presence server address and a presentity URI. The presence information management system in the first embodiment has only one default server 10, however, if two or more default servers 10 exist, addresses thereof are set respectively in the default server address field in this delegator presence server information table.

<<Delegatee Server Determining Unit>>

The delegatee server determining unit 208 determines, based on the information within the presence information management DB 205 managed by the presence information management unit 203, the default presence server or the in-site presence server of another site, which delegates the presence server function. To be specific, the delegatee server determining unit 208 judges the delegating condition in the presence information table, thereby determining as to whether the presence server function about every presentity is delegated or not and determining the delegatee site or the default presence server.

The delegatee server determining unit 208, when judging that the delegating condition in the presence information table is not satisfied, determines to transfer the presence server function related to the presentity back to the default server set in the delegator presence server information table. For example, when 50% is set as the delegating condition of a presentity 31 in the presence information table shown in FIG. 3 and if a watcher count in the site 2 does not reach 50% of the whole, it is determined that the presence server function is transferred back to the default server of the delegator.

Further, the delegatee server determining unit 208, when judging that the delegating condition in the presence information table is satisfied in regard to the watchers within another new site, determines to delegate the presence server function to the in-site server in this new site.

The delegatee server determining unit 208, in the case of determining the default server as the delegatee, acquires the address information of this default server from the information within the delegator presence server information management DB 206, and sends the address information thereof and a purport that the delegation is done to the presence control unit 202. Moreover, the delegatee server determining unit 208, in the case of determining the in-site presence server of another site as the delegatee, specifies the in-site presence server determined as the delegatee on the basis of the address information of each in-site presence server that is separately previously retained, and notifies the presence control unit 202 of the purport that the delegation is done and of the address information of the in-site presence server. The presence control unit 202 instructs the delegator presence server information management unit 204 to delete the information on the presentity for which the presence server function is delegated from the delegator presence server information DB 206.

<Clients (Watcher and Presentity)>>

The clients 21, 22, 23, 31, 32, 41 and 42 are the client devices provided with the presence service and also devices eligible for the watchers and for the presentities. Note that the clients 21, 22, 23, 31, 32, 41 and 42 are the devices each having the same function, and hence the following discussion shall give the description with their numerals and symbols omitted except a case of requiring a distinction therebetween.

The client is the computer including the CPU, the memory, the input/output interface, etc, wherein the CPU executes the control program stored in the memory such as the hard disc, thereby actualizing the client function that will be described as follows. Note that the client may also be a client having a function other than the function, which will hereinafter be explained.

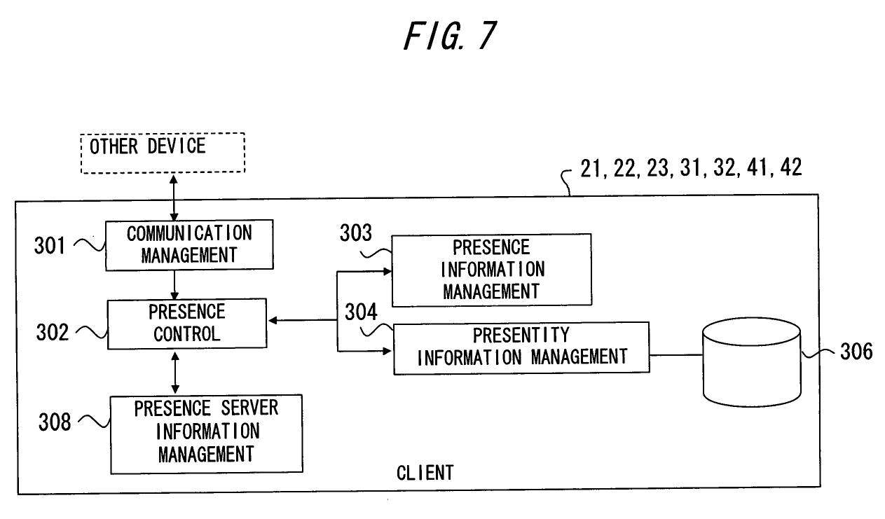

The client has a functional configuration shown in FIG. 7 as the client function. FIG. 7 is a block diagram showing the functional configuration of the client in the first embodiment. The client has a communication management unit 301 (corresponding to notifying unit, change notifying unit and notification receiving unit according to the present invention), a presence control unit 302 (corresponding to notifying unit and change notifying unit according to the present invention), a presence information management unit 303, a presentity information management unit 304, a presence server information management unit 308 and so on. These respective functional units will be described, respectively. It is to be noted that the default server 10 or the in-site server 20 will hereafter be termed the presence server as the case may be.

<<Communication Management Unit>>

The communication management unit 301 receives self-addressed messages from other devices such as the default server 10 and the in-site server 20, and sends messages addressed to other devices. The communication management unit 301, as shown in FIG. 21, if the self-device becomes the watcher, sends the presence disclosure request (SUBSCRIBE) to the presence server related to the target presentity, and receives, from the presence server, the presence notification (NOTIFY) sent from a desire presentity. The communication management unit 301, if the self-device becomes the presentity, sends the presence changing notification to the presence server.

The communication management unit 301, when receiving the messages, transfers a presence service related message in the received messages to the presence control unit 302. Moreover, the communication management unit 301, when sending the messages, receives the presence service related message from the presence control unit 302, and sends this message.

<<Presence Control Unit>>

The presence control unit 302, in order to actualize the client function in the presence service, controls the presence information management unit 303, the presentity information management unit 304 and the presence server information management unit 308. Functions given below are exemplified as those actualized by the presence control unit 302. These functions are a watcher function (function 1), a presentity function (function 2) and a function (function 3) of recognizing a change of the presence server.

As the (function 1), the presence control unit 302 instructs the communication management unit 301 to transmit the SUBSCRIBE of the target presentity to the presence server. At this time, the presence control unit 302 acquires the address information etc of the presence server from the presence server information management unit 308. Further, the presence control unit 302 acquires the information (address information etc) about the SUBSCRIBE target presentity from other input devices etc, and transfers this information to the presentity information management unit 304.

As the (function 2), the presence control unit 302, when receiving from the presence information management unit 303 the notification that the presence information has been changed, instructs the communication management unit 301 to send the presence changing notification to the presence server related to the self-device. At this time, the presence control unit 302 obtains the address information etc of the presence server from the presence server information management unit 308.

As the function (3), the presence control unit 302, when receiving the presence server changing notification from the communication management unit 301, transfers the information about the delegatee presence server, which is contained in this notification, to the presence server information management unit 308.

<<Presence Information Management Unit>>

The presence information management unit 303, in order for the self-device to operate as the presentity, manages the presence information of the self-device. The presence information management unit 303, if the self-device becomes the presentity, upon detecting that the presence information has been changed, notifies the presence control unit 302 of the purport that the presence information has been changed and of the post-changing presence information. It should be noted that the present invention does not limit the presence information managed herein.

<<Presentity Information Management Unit>>

The presentity information management unit 304, in order for the self-device to operate as the watcher, manages the information about the each target presentity and the information about the presence server for each presentity. These items of information are retained in a presentity information management database (DB) 306.

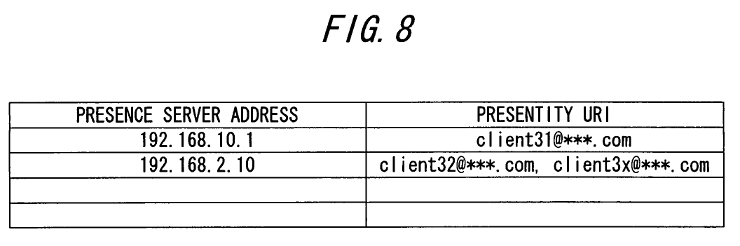

FIG. 8 is a diagram showing a presentity information table within the presentity information management DB 306. The presentity information table retains, with respect to every presentity, the address information of the presence server related to the presentity, respectively. Specifically, the presentity information table retains a presence server address and a presentity URI.

<<Presence Server Information Management Unit>>

The presence server information management unit 308 manages the information on the presence server. The presence server information management unit 308 normally manages the information on the default server 10 operating as the presence server and, when the presence server changing notification is received and when the information about the delegatee presence server which is contained in this notification is transferred from the presence control unit 302, manages the information about this delegatee presence server. The thus-managed information about the presence server is transferred to the presentity information management unit 304.

### OPERATIONAL EXAMPLE

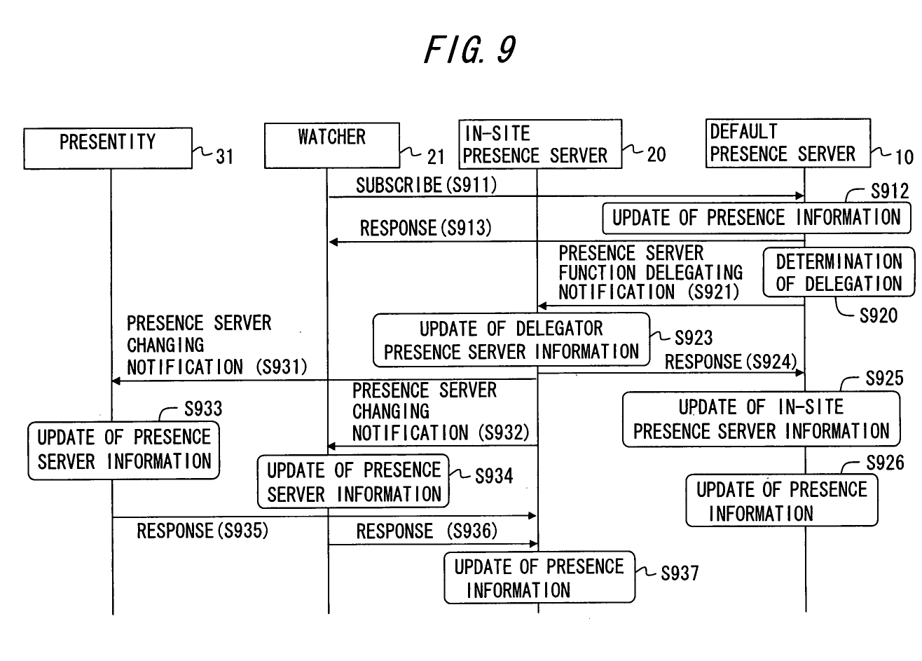

An operational example of the presence information management system in the first embodiment will hereinafter be described with reference to FIGS. 9, 10, 11A, 11B and 12.

To start with, the operation in a case that the presence server function is delegated to the in-site server 20 from the default server 10, will be explained with reference to FIG. 9. FIG. 9 is a sequence diagram showing the operational example when delegating the presence server function to the in-site server 20 from the default server 10, wherein this operational example is exemplified in such a case that the client 31 is the presentity, while the client 21 is the watcher requesting the presence information of this client 31 in the system architecture in FIG. 1.

In an initial state of the system operation, the default server 10 has the presence server function for all of the presentities, and hence the watcher 21 sends the SUBSCRIBE for requesting the presence information of the presentity 31 to the default server 10. (S911).

The default server 10 receiving the SUBSCRIBE, if the presence server function of the SUBSCRIBE target presentity 31 is not delegated, judges by referring to the in-site presence server information table within the in-site server information management DB 106. Namely, the default server 10 judges that there is no necessity of redirecting the SUBSCRIBE.

Subsequently, the default server 10 updates the presence information table within the presence information management DB 105 with the information contained in the SUBSCRIBE received (S912). To be specific, a URI of the SUBSCRIBE target presentity 31 is set in the presentity URI field in the presence information table, and a URI of the watcher 21 as the sender of the SUBSCRIBE is set in the watcher URI field in the same table. Then, the default server 10 gives a response that the reception of the SUBSCRIBE gets successful (S913).

Thereafter, the default server 10 judges the delegating condition set in the presence information table with respect to every presentity, thereby determining to delegate the presence server function according to the necessity (S920). For instance, if a watcher count for a certain presentity becomes larger than a predetermined threshold value (set value), the default server 10 determines to delegate the presence server function. Further, the default server 10 determines to delegate the presence server function according to a delegating condition set based on a behavior pattern of the watcher for a certain presentity, e.g., a condition of delegating the presence server function to a predetermined site in a predetermined time zone. Herein, it is assumed that the presence server function related to the presentity 31 is determined to be delegated to the in-site server 20 from the default server 10.

In the default server 10, when determining to delegate the presence server function, the delegatee server determining unit 108 acquires the address information etc of the in-site presence server of the delegatee. The default server 10 sends the presence server function delegating notification to the in-site server 20 determined as the delegatee server (S921). The default server 10 contains the information (the URI etc of the client 31) about the target presentity and the information (the URI etc of the client 21) about all of the watchers of this presentity, to this presence server function delegating notification.

The in-site server 20, when receiving this presence server function delegating notification, updates the delegator presence server information table within the delegator presence server information management DB 206 (S923). At this time, the information about the target presentity 31 that is contained in this presence server function delegating notification and the information about the default server 10 as the sender of this notification, are set in the delegator presence server information table. Thereafter, the in-site server 20 sends a response to this notification to the sender default server 10 (S924). Along with this, the in-site server 20 transmits the presence server changing notification to the target presentity 31 and to the watcher 21 of this presentity 31 on the basis of the information contained in the presence server function delegating notification (S931, S932). This presence server changing notification contains the information on the delegatee presence server.

The default server 10, when receiving the response (S924) to the presence server function delegating notification (S921), sets the URI of the delegation-determined presentity 31 and the address of the in-site server 20 determined as the delegatee server, in the in-site presence server information table within the in-site presence server information management DB 106 (S925). The default server 10 deletes the information on the presentity 31 from the presence information table within the presence information management DB 105 (S926).

The watcher 21 receiving the presence server changing notification (S932) sets, based on the information contained in this notification, the information about the in-site server 20 as the presence server related to the target presentity 31 in the presentity information table within the presentity information management DB 306 (S934).

Further, the presentity 31 receiving the presence server changing notification (S931) retains, based on the information contained in this notification, the information about the in-site server 20 as the presence server for the presentity 31 itself (S933). Thereafter, the watcher 21 and the presentity 31 send responses to the presence server changing notification (S931, S932), respectively (S935, S936).

The in-site server 20 receiving the responses (S935, S936) from the watcher 21 and the presentity 31 sets the URI of the watcher 21 and the URI of the presentity 31 in the presence information table within the presence information management DB 205 (S937).

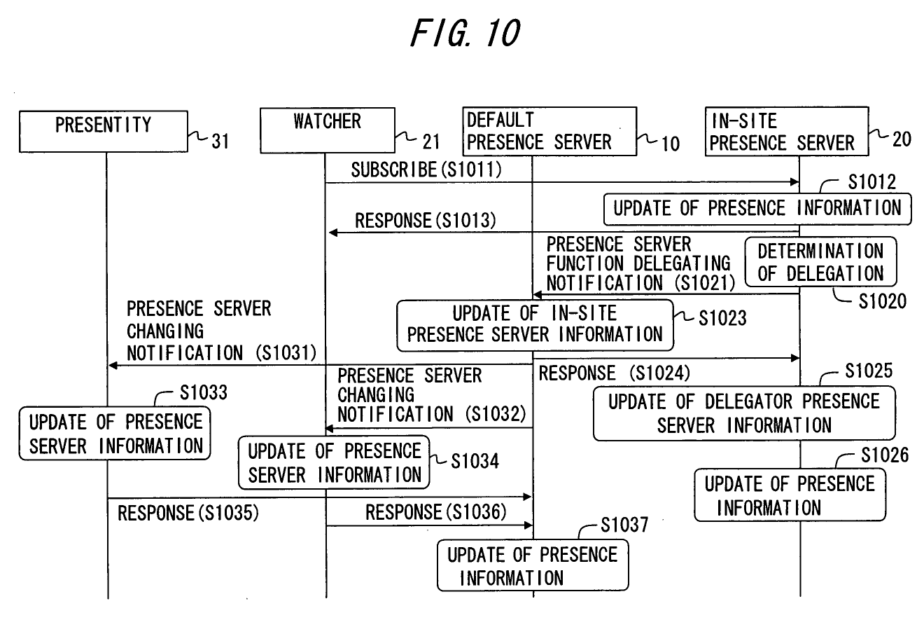

Next, an operation in the case of delegating (transferring back) the presence server function to the default server 10 from the in-site server 20 to which the presence server function was delegated as described above, will be explained with reference to FIG. 10. FIG. 10 is a sequence diagram showing an operational example when delegating the presence server function to the default server 10 from the in-site server 20, wherein this operational example is exemplified in such a case that the client 31 is the presentity while the client 21 is the watcher requesting the presence information of this client 31 in the system architecture in FIG. 1, and the presence server function for the presentity 31 is delegated to the in-site server 20.

The presence server function for the presentity 31 is delegated to the in-site server 20, and hence the watcher 21 transmits the SUBSCRIBE for requesting the presence information of the presentity 31 to the in-site server 20 (S1011). At this time, the watcher 21 refers to the presentity information table within the presentity information management DB 306, thereby knowing that the in-site server 20 holds the presence server function for the presentity 31.

The in-site server 20 receiving this SUBSCRIBE updates the presence information table within the presence information management DB 205 with the information contained in the SUBSCRIBE received (S1012). To be specific, the URI of the SUBSCRIBE target presentity 31 is set in the presentity URI field in the presence information table, and the URI of the watcher 21 as the sender of the SUBSCRIBE is set in the watcher URI field in the same table. Then, the in-site server 20 gives a response showing that the reception of the SUBSCRIBE gets successful (S1013).

Thereafter, the in-site server 20 judges the delegating condition set in the presence information table with respect to every presentity, thereby determining to delegate the presence server function according to the necessity (S1020). The determination of the delegation of this presence server function is the same as done by the default server 10 described above. Herein, an assumption is that the presence server function related to the presentity 31 should, it is determined, be transferred back to the default server 10 from the in-site server 20.

In the in-site server 20, when determining to delegate the presence server function, the address information etc of the default server 10 becoming the delegatee server thereof is acquired from the delegator presence server information management unit 204. At this time, the in-site server 20 specifies the default server 10 as the delegatee server on the basis of the address of the default presence server for the presentity 31, which is stored in the delegator presence server information table. The in-site server 20 sends the presence server function delegating notification to the default server 10 determined as the delegatee server thereof (S1021). The in-site server 20 contains the information (the URI etc of the client 31) about the target presentity and the information (the URI etc of the client 21) about all of the watchers of this presentity in this presence server function delegating notification.

The default server 10, when receiving this presence server function delegating notification, deletes the information about the presentity 31 from the in-site presence server information table (S1023). Thereafter, the default server 10 sends a response to this notification to the in-site server 20 as the sender (S1024). Along with this, the default server 10 transmits the presence server changing notification to the target presentity 31 and to the watcher 21 of this presentity 31 on the basis of the information contained in this presence server function delegating notification (S1031, S1032). This presence server changing notification contains the information on the default server 10 as the delegatee presence server.

The in-site server 20, when receiving the response (S1024) to the presence server function delegating notification (S1021), deletes the information about the delegation-determined presentity 31 from the delegator presence server information table (S1025).

The watcher 21 receiving the presence server changing notification (S1032) sets, based on the information contained in this notification, the information about the default server 10 as the presence server related to the target presentity 31 in the presentity information table within the presentity information management DB 306 (S1034).

Further, the presentity 31 receiving the presence server changing notification (S1031) retains, based on the information contained in this notification, the information about the default server 10 as the presence server (S1033). Thereafter, the watcher 21 and the presentity 31 transmit responses to this presence server changing notification (S1031, S1032), respectively (S1035, S1036).

The default server 10 receiving the responses (S1035, S1036) from the watcher 21 and from the presentity 31, sets the URI of the watcher 21 and the URI of the presentity 31 in the presence information table (S1037).

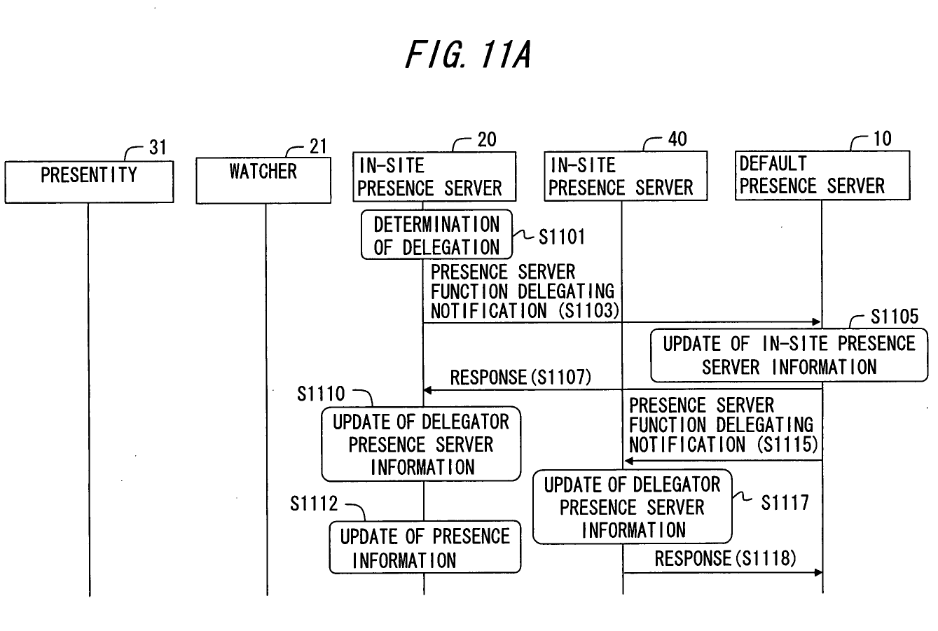

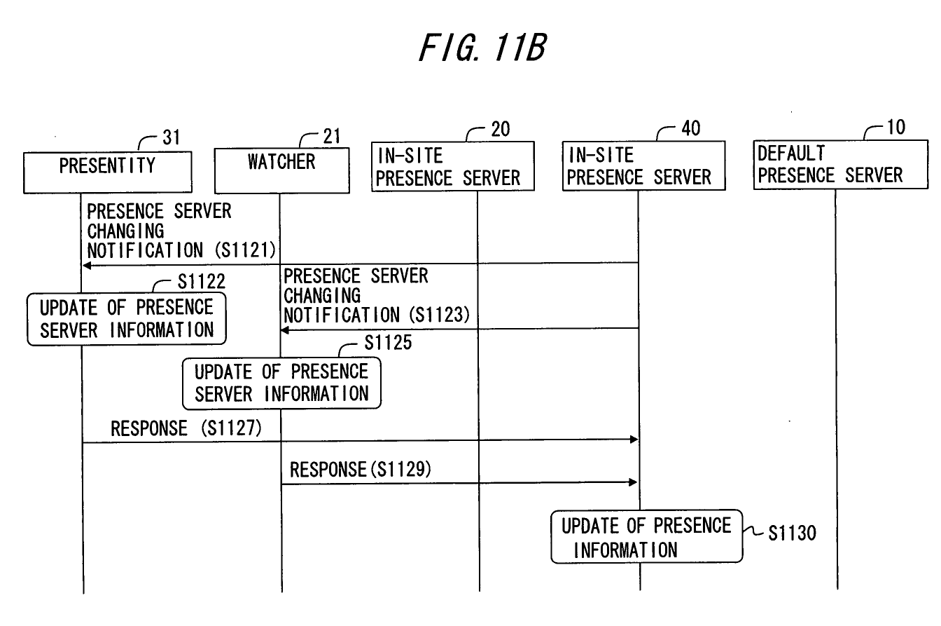

Next, an operation in the case of delegating the presence server function to the in-site server 40 of another site from the in-site server 20 to which the presence server function was delegated as described above, will be described with reference to FIGS. 11A and 11B. FIGS. 11A and 11B are sequence diagrams showing an operational example when delegating the presence server function to the in-site server 40 from the in-site server 20, wherein this operational example is exemplified in such a case that the client 31 is the presentity, while the client 21 is the watcher requesting the presence information of this client 31 in the system architecture in FIG. 1.

If the presence server function for the presentity 31 is delegated to the in-site server 20, the in-site server 20 judges the delegating condition set in the presence information table, thereby determining to delegate the presence server function related to the presentity 31 to the in-site server 40 (S1101).

In the in-site server 20, when determining to delegate the presence server function, the address etc of the in-site server 40 becoming the delegatee server is acquired from the delegatee server determining unit 208. Further, the in-site server 20 acquires the address of the default presence server with respect to the presentity 31 from the delegator presence server information table. The in-site server 20 transmits the presence server function delegating notification containing the information about the in-site server 40 determined as the delegatee server to the acquired default presence server address as a destination (S1103). Moreover, the in-site server 20 contains the information (the URI etc of the client 31) about the target presentity and the information (the URI etc of the client 21) about all of the watchers of this presentity in this presence server function delegating notification.

The default server 10, when receiving this presence server function delegating notification (S1103), updates the information about the presentity 31 that is stored in the in-site presence server information table (S1105). At this time, the address of the in-site server 40 of the delegatee is set in the in-site presence server address field with respect to the presentity 31 in the in-site presence server information table. Thereafter, the default server 10 transmits a response to this notification to the in-site server 20 defined as the sender (S1107). Along with this, the default server 10 transfers the presence server function delegating notification to the in-site server 40 of the delegatee (S1115).

The in-site server 20, when receiving the response (S1107) to the presence server function delegating notification (S1103), deletes the information about the delegation-determined presentity 31 from the delegator presence server information table (S1110). Further, the in-site server 20 deletes the information about the delegation-determined presentity 31 from the presence information table (S1112).

On the other hand, the in-site server 40 receiving the presence server function delegating notification (S1115) sets the information about the presentity 31 becoming the notification target device in the delegator presence server information table. To be specific, the in-site server 40 sets the URI of the presentity 31 and the address information of the default server 10 as the default presence server address. Thereafter, the in-site server 40 transmits a response to this presence server function delegating notification (S1118).

The in-site server 40 transmits, based on the information contained in the presence server function delegating notification, the presence server changing notification to the target presentity 31 and to the watcher 21 of this presentity 31 (S1121, S1123). This presence server changing notification contains the information about the in-site presence server 40 as the delegatee presence server.

The watcher 21 receiving the presence server changing notification (S1123) sets, based on the information contained in this notification, the information about the in-site server 40 as the presence server related to the target presentity 31, in the presentity information table (S1125).

Further, the presentity 31 receiving the presence server changing notification (S1121) retains the information on the in-site server 40 as the presence server on the basis of the information contained in this notification (S1122). Thereafter, the watcher 21 and the presentity 31 transmit responses to the presence server changing notification (S1121, S1123), respectively (S1127, S1129).

The in-site server 40 receiving the responses (S1127, S1129) from the watcher 21 and from the presentity 31 sets the URI of the watcher 21 and the URI of the presentity 31 in the presence information table (S1130).

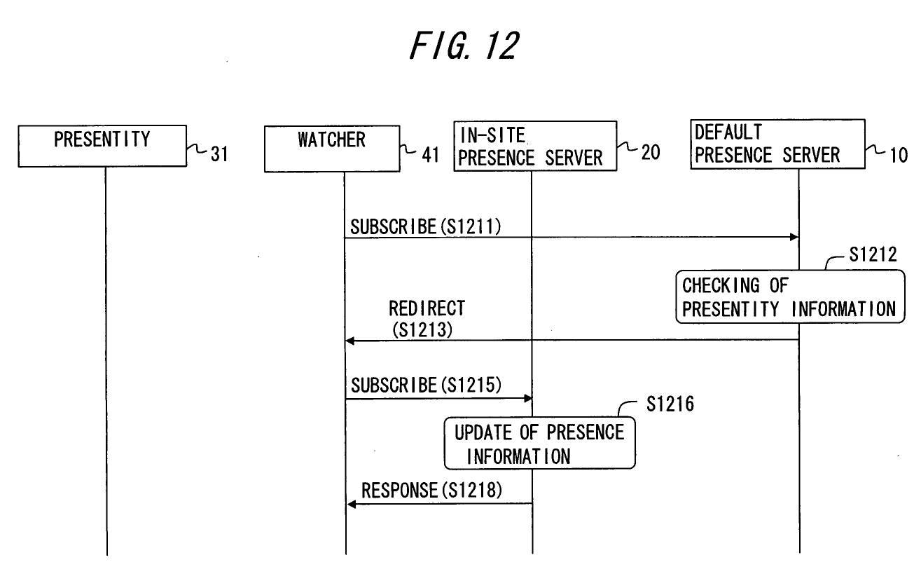

Next, an operation in the case of transmitting the SUBSCRIBE to the default server 10 from the watcher 21 in a state of delegating the presence server function for the presentity 31 to the in-site server 20 as described above, will be explained with reference to FIG. 12. FIG. 12 is a sequence diagram showing an operational example when redirecting the SUBSCRIBE in the default presence server 10, wherein this operational example is exemplified in such a case that the client 31 is the presentity while the client 41 is the watcher requesting the presence information of this client 31 in the system architecture in FIG. 1, and the presence server function for the presentity 31 is delegated to the in-site server 20.

The presence server function for the presentity 31 is delegated to the in-site server 20, and nevertheless the watcher 41 does not know it, in which case the watcher 41 sends the SUBSCRIBE for requesting the presence information of the presentity 31 to the default server 10 (S1211).

The default server 10, upon receiving this SUBSCRIBE, checks whether or not the information about the target presentity 31 is set in the in-site presence server information table (S1212). The default server 10, when judging that the information is set therein, acquires the address of the in-site server 20 related to the presentity 31 set in the in-site presence server information table, and sends (redirects) a message containing this address to the watcher 41 (S1213).

The watcher 41, when receiving the redirection of the SUBSCRIBE (S1211) sent earlier (S1213), transmits the SUBSCRIBE to the in-site server 20 of the delegatee contained in that message (S1215).

With this operation, the in-site server 20 accepts the SUBSCRIBE related to the presentity 31, then updates the presence information table (S1216), and makes a response showing this purport (S1218).

### Operation and Effect in First Embodiment

Herein, an operation and an effect of the presence information management system in the first embodiment discussed above will be described.

In the presence information management system in the first embodiment, the presence server function is delegated per presentity to the in-site server 20 or 40 from the default server 10.

In the default server 10, with respect to every presentity, the information about the watcher requesting the presence information thereof and the delegating condition are retained in the presence information management DB 105. Then, the presentity satisfying this delegating condition is determined as the target presentity for which the presence server function is delegated. Thereafter, the presence server function delegating notification containing the information about the delegation target presentity and the information about the watcher thereof, is transmitted to the in-site server of the site determined as the delegatee site.

In the in-site server receiving this presence server function delegating notification, the management of the presence information about the target presentity is hereafter started. Namely, the presence information of this presentity is retained in the presence information management DB 205, and the presence server function related to this presentity is executed.

With this operation, according to the first embodiment, for instance, if the watchers requesting the presence information about the predetermined presentity exist concentratedly within a certain site and if such a delegating condition is set that the presence server function be delegated to the in-site server located at this site, the presence server function of this presentity can be delegated to this in-site server.

Accordingly, it is possible to reduce communication quantity flowing across a core network between the delegatee site and the server site where the default server exists, i.e., to reduce the communication quantity that is reducible in terms of the system architecture.

Moreover, the presence server function to be delegated includes a function of, in the case of receiving the presence information changing notification of the presence information from the presentity, NOTIFYing the watcher of this received presence information, and therefore, even when the delegation of the presence server function is executed, the realtime notification of the presence information is actualized as it is.

Further, in the in-site server of the delegatee, on the basis of the presentity information contained in the presence server function delegating notification and the watcher information, the presence server function changing notification is transmitted to the presentity and to the watcher. With this operation, the presentity and the watcher can recognize a delegated result.

Further, in the in-site server of the delegatee, with respect to the delegated presentity, the delegation to the in-site server of another site or to the default server is determined. In regard to the presentity that does not satisfy the delegating condition, the presence server function can be thereby transferred back to the default server. Further, the delegation to a more proper in-site server can be done.

Moreover, in the case of transmitting the SUBSCRIBE to the default server from the watcher that does not know the delegation, in the default server, the information of the in-site server of the delegatee is retained with respect to each presentity, and therefore a response containing the retained information about the in-site server of the delegatee is transmitted to this watcher.

With this operation, the watcher receiving this response can recognize that the presence server function related to the presentity has been delegated to the in-site server, and the SUBSCRIBE can be transmitted to this in-site server.

### Second Embodiment

The presence information management system in a second embodiment of the present invention will hereinafter be described. In the presence information management system in the first embodiment explained earlier, basically the presence server function operates on the default presence server, and, when the default presence server determines to delegate the presence server function, the presence server function is delegated to the in-site presence server determined as the delegatee server. The presence information management system in the second embodiment is such that each in-site presence server previously has the presence server function. Note that the system architecture shall be the same as in the first embodiment illustrated in FIG. 1. The default server 10 in the second embodiment corresponds to a first presence server according to the present invention, and the in-site servers 20 and 40 each correspond to a second presence server according to the present invention.

[Configuration of Device]

The device configurations of the default server 10, the in-site servers 20, 40, and the clients 21, 22, 23, 31, 32, 41, 42, which configure the presence information management system in the second embodiment, will hereinafter be explained, respectively. Note that the hardware configurations of the respective devices have no different point from those in the first embodiment, and hence their explanations are omitted.

<Default Presence Server>

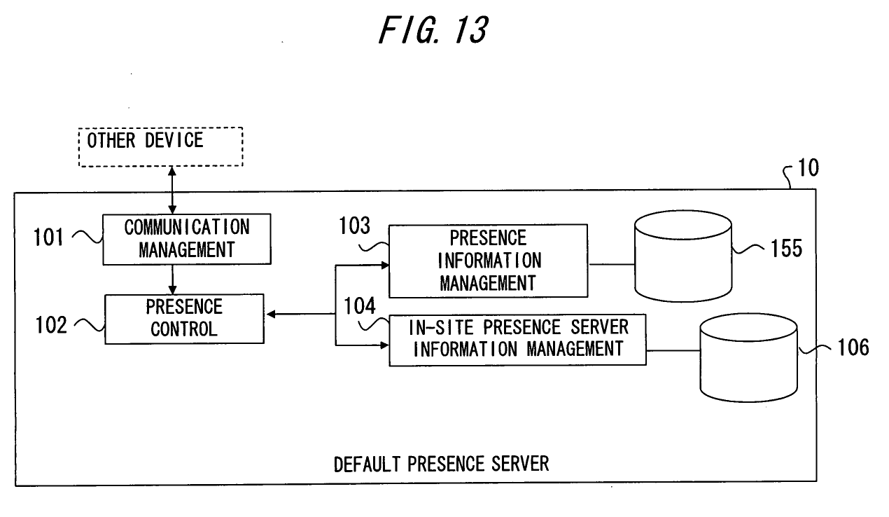

The default server 10 in the second embodiment provides the presence service to each of the clients of which the presence information is not managed by the in-site server. The client of which the presence information is not managed by the in-site server is exemplified by, for instance, a client in a site where the in-site server does not exist. FIG. 13 is a block diagram showing a functional configuration of the default server 10 in the second embodiment. The functional configuration of the default server 10 in the second embodiment is the same as that of the default server in the first embodiment, except having none of the delegatee server determining unit 108. The discussion will hereinafter be focused on the functional units having different functions as those of the default server 10 in the first embodiment.

<<Presence Control Unit>>

The presence control unit 102, in order to actualize the presence server function in the case of receiving a presence service related message from the communication management unit 101, controls the presence information management unit 103 and the in-site presence server information management unit 104. The functions actualized by the presence control unit 102 are a general presence server function (function 1), and a function (function 2) of notifying, in the case of receiving the SUBSCRIBE to the presentity of which the presence information is managed by the in-site presence server, a sender that the SUBSCRIBE be redirected to the in-site presence server managing the presentity.

As the (function 1), the presence control unit 102 provides the presence information to the watcher of the presentity of which the presence information is managed by the self-device. To be specific, the presence control unit 102, upon receiving the SUBSCRIBE from the watcher, acquires, from this message, the information about the watcher as the SUBSCRIBE sender and the information about the SUBSCRIBE target presentity, and makes the in-site presence server information management unit 104 judge whether or not the presence information of the SUBSCRIBE target presentity is managed by the self-device. The presence control unit 102, if the presence information of the presentity is managed by the self-device, transfers the information acquired from the SUBSCRIBE to the presence information management unit 103. Then, the presence control unit 102 instructs the communication management unit 101 to notify (NOTIFY) the watcher, as the SUBSCRIBE sender, of the presence information of the target presentity.

Further, the presence control unit 102, when receiving the presence changing notification from the presentity managed by the self-device, instructs the presence information management unit 103 to retain the presence information, and, along with this, instructs the communication management unit 101 to transmit the changed presence information to the watcher related to this presentity. The presence control unit 102, for actualizing the (function 1), instructs the presence information management unit 103 to retain and manage a watcher count, location information, etc related to each of the predetermined presentities.

The presence control unit 102, in order to actualize the (function 2), in the case of receiving the SUBSCRIBE to the presentity of which the presence information is not managed by the self-device, instructs the communication management unit 101 to notify (redirect) the watcher, as the SUBSCRIBE sender, of the in-site presence server managing the presence information of this presentity. At this time, the presence control unit 102 acquires the information from the in-site presence server information management unit 104, concerning whether or not there is the in-site presence server having the presence server function with respect to the target presentity and concerning the URI of the in-site presence server.

<<Presence Information Management Unit>>

The presence information management unit 103 manages the information about each presentity whose presence information is managed by the self-device, which is transferred from the presence control unit 102 as described above. A presence information management database (DB) 155 retains the presence information about each presentity to be managed and the information about the watcher making the SUBSCRIBE.

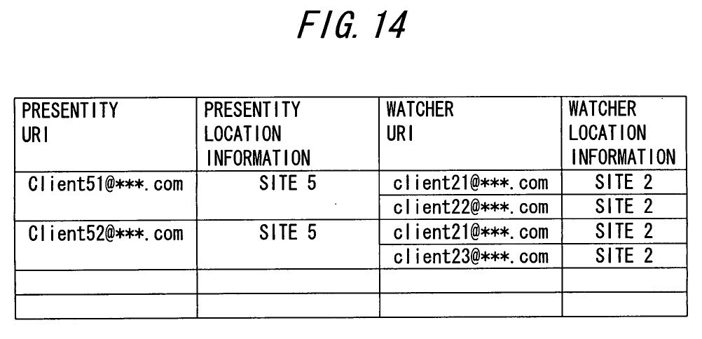

FIG. 14 is a diagram showing a presence information table within the presence information management DB 155. The presence information table in the second embodiment is a table having no delegating condition field in the presence information table in the first embodiment. This presence information table retains the presentity of which the presence information is managed by the default server 10.

<<In-Site Presence Server Information Management Unit>>

The in-site presence server information management unit 104 manages, with respect to the presentity of which the presence information is managed by the in-site presence server, the information on this presentity and on the in-site presence server thereof. These items of information are retained in the in-site presence server information management database (DB) 106. The information (the in-site presence server information table) retained in the in-site presence server information management DB 106 is the same in the first embodiment. It should be noted that the in-site presence server information management unit 104 corresponds to retaining unit according to the present invention.

<In-Site Presence Server>

The in-site servers 20, 40 in the second embodiment provide the respective clients with the presence service related to the presentity within the same site or a predetermined site. Note that the in-site servers 20 and 40 are the devices each having the same function, and therefore the following discussion shall give the description with their numerals and symbols omitted except a case of requiring a distinction therebetween.

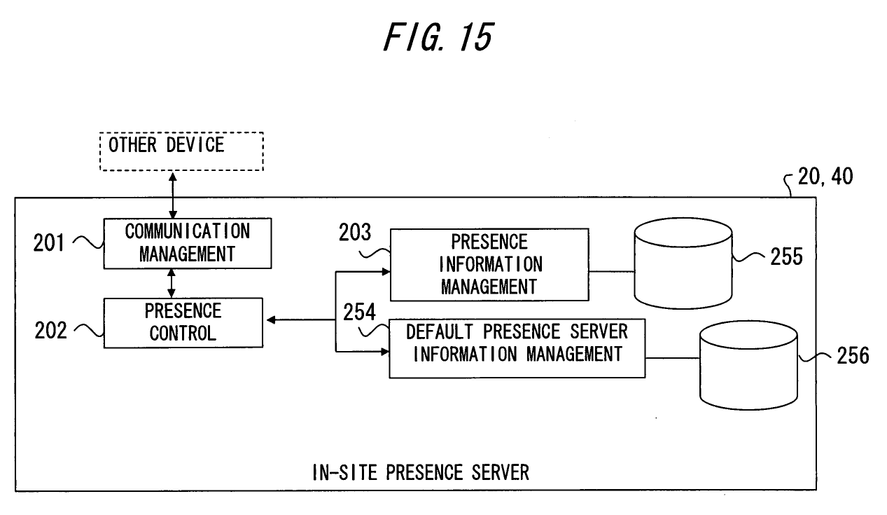

The in-site server in the second embodiment has a functional configuration illustrated in FIG. 15 as of an in-site presence server function. FIG. 15 is a block diagram showing the functional configuration of the in-site presence server in the second embodiment. The in-site server has the communication management unit 201, the presence control unit 202 (corresponding to start notifying unit according to the present invention), the presence information management unit 203 (corresponding to managing unit according to the present invention), a default presence server information management unit 254 and so on. The discussion will hereinafter be focused respectively on the functional units having different functions from those in the first embodiment.

<<Communication Management Unit>>

The communication management unit 201, when receiving the presence service related message about the presentity of which the presence information is managed by the self-device (in-site server), transfers the received message to the presence control unit 202. Further, the communication management unit 201 sends the presence service related message transferred from the presence control unit 202.

<<Presence Control Unit>>

The presence control unit 202, in order to actualize the in-site presence server function with respect to the presentity of which the presence information is managed by the self-device, controls the presence information management unit 203 and the default presence server information management unit 254. The functions actualized by the presence control unit 202 are a general presence server function (function 1), a function (function 2) of registering the client (presentity) of which the presence information should be managed, and a function (function 3) of notifying the default presence server of the information about the presentity whose presence information is managed by the self-device.

As the (function 1), the presence control unit 202, upon receiving the SUBSCRIBE from the watcher with respect to the presentity of which the presence information is managed by the self-device, transfers the information about the watcher becoming the SUBSCRIBE sender and the information on this presentity to the presence information management unit 203. On the other hand, the presence control unit 202 instructs the communication management unit 201 to transmit (NOTIFY) the presence information of this presentity to the sender watcher. Further, the presence control unit 202, when receiving the presence changing notification from the presentity of which the presence information is managed by the self-device, instructs the presence information management unit 203 to retain the presence information, and, along with this, instructs the communication management unit 201 to notify (NOTIFY) the watcher, related to this presentity, of the changed presence information.

The presence control unit 202, for actualizing the (function 1), instructs the presence information management unit 203 to retain the watcher count, the location information, etc with respect to every presentity of which the presence information is managed by the self-device. Moreover, the presence control unit 202, if required to judge whether it is the presentity of which the presence information is managed by the self-device or not, acquires the information from the presence information management unit 203.

Further, the presence control unit 202, for actualize the (function 2), when receiving a registration request for using the presence service from the client (presentity), transfers the information on the client to the presence information management unit 203. With this transfer, the information on the presentity is registered in a presence information management DB 255. With this registration, it follows that the presence information of this presentity is managed by this in-site server.

Moreover, in order to actualize the (function 3), the presence control unit 202, when receiving the registration request for using the presence service from the client, instructs the communication management unit 201 to notify the default server 10 of the purport that the presence information on the client (presentity) is managed by the self-device. Along with this, the presence control unit 202 instructs the default presence server information management unit 254 to manage the information of the default server with respect to this client.

<<Presence Information Management Unit>>

The presence information management unit 203 manages the presence information about each presentity whose presence information should be managed by the self-device, which is transferred from the presence control unit 202 as described above, and manages the information about the watcher making the SUBSCRIBE. These items of information are retained in the presence information management database (DB) 255. The information etc retained in the presence information management DB 255 is the same as in the presence information management DB 155 of the default server 10, and hence its explanation is omitted.

<<Default Presence Server Information Management Unit>>

The default presence server information management unit 254 manages the information about the default presence server of the presentity of which the presence information is managed by the self-device. The information on this default presence server is retained in the default presence server information management database (DB) 256. This default presence server information management DB 256 retains the default presence server information table. The information retained in this default presence server information table is the same as the information in the delegator presence server information table in the first embodiment illustrated in FIG. 6. Namely, the default presence server information table retains the information on each default presence server with respect to every presentity.

<Client (Watcher and Presentity)>

The clients 21, 22, 23, 31, 32, 41 and 42 in the second embodiment are the client devices provided with the presence service and also devices eligible for the watchers and for the presentities. Note that the clients 21, 22, 23, 31, 32, 41 and 42 are the devices each having the same function also in the second embodiment, and hence the following discussion shall give the description with their numerals and symbols omitted except a case of requiring a distinction therebetween. These clients in the second embodiment each have the same functional configuration as that in the first embodiment illustrated in FIG. 7. The discussion will hereinafter be focused respectively on the functional units having different functions from those in the first embodiment.

<<Presence Control Unit>>

The presence control unit 302 has, in place of the function (function 3) of recognizing the change of the presence server in the first embodiment, a function (function 3) of retaining information showing which server, the default server 10 or the in-site server 20 or 40, is made to manage the presence information of the self-device if the self-device is the presentity, and other operations are the same as in the first embodiment. It should be noted that the presence control unit 302 corresponds to request transmitting unit according to the present invention.

As this new (function 3), the presence control unit 302 obtains from, the presence server information management unit 308, the information showing which server, the default server 10 or the in-site server 20 or 40, is made to manage the presence information of the self-device, and instructs the communication management unit 301 to transmit the registration request for using the presence service to this predetermined server.

<<Presence Server Information Management Unit>>

The presence server information management unit 308 manages the information showing which server, the default server 10 or the in-site server 20 or 40, is made to manage the presence information of the self-device. The presence server information management unit 308 normally manages the information about the default server 10 serving as the presence server and, for example, if the in-site presence server exists in the same site, manages the information about the in-site presence server as the presence server.

### OPERATIONAL EXAMPLE

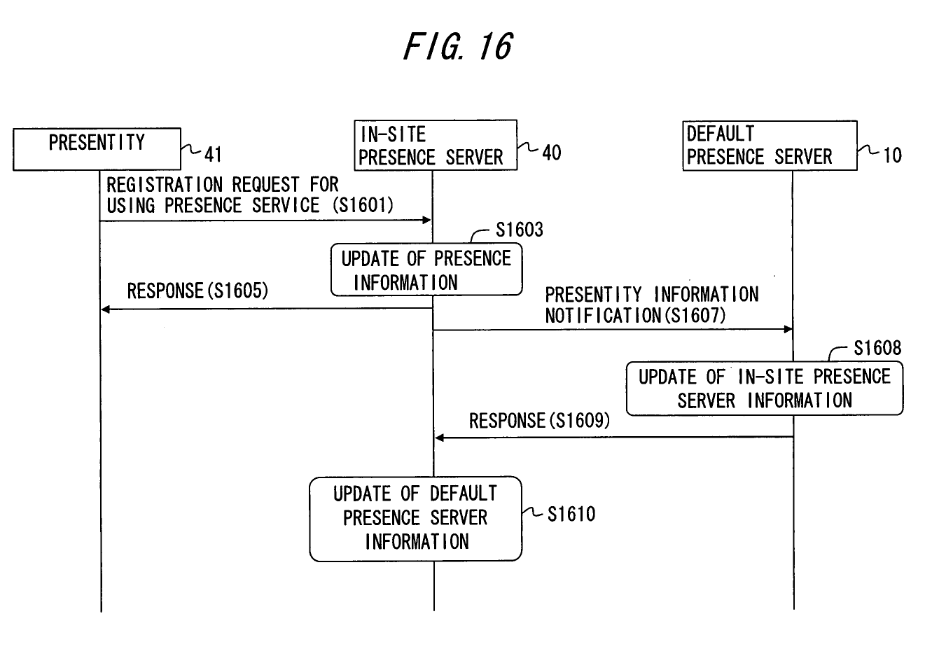

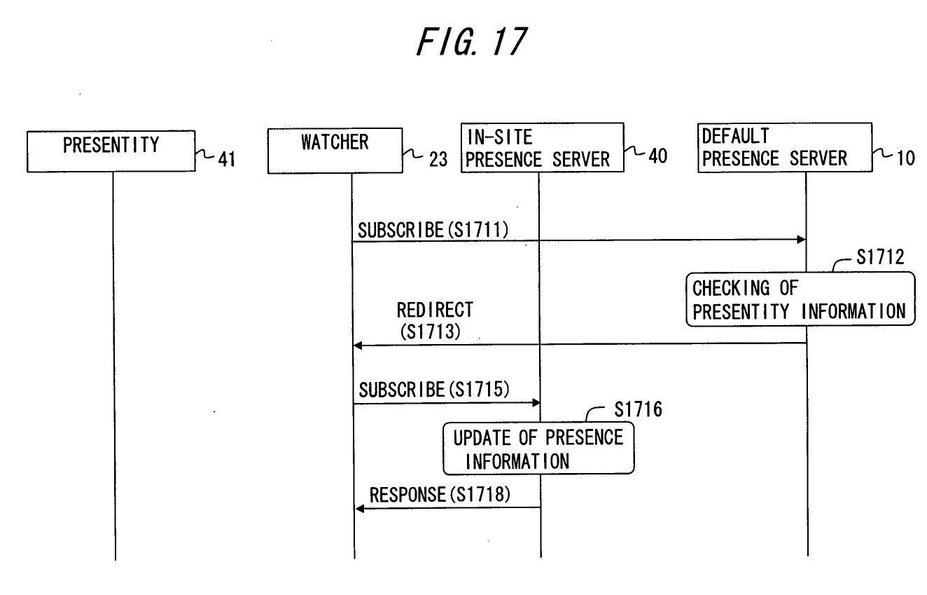

An operational example of the presence information management system in the second embodiment will hereinafter be described with reference to FIGS. 16 and 17.

To start with, an operation on such an occasion that the client becoming the presentity starts providing the presence information of the presentity itself, will be explained with reference to FIG. 16. FIG. 16 is a sequence diagram showing the operational example when making the registration request for using the presence service.

The client 41 becoming the presentity transmits the registration request for using the presence service to the in-site server 40 as a server managed by the presence server information management unit 308 on the occasion of starting providing the presence information (S1601).

The in-site server 40 receiving this registration request for using the presence service registers the information such as the URI etc about the client 41 as the sender in the presence information table (S1603). With this registration, it follows that the presence information of the presentity 41 is hereafter managed by this in-site server 40. Thereafter, the in-site server 40 sends a response showing “the registration being already done” to the client 41 (S1605).

Moreover, the in-site server 40 sends, to the default server 10, presentity information notification purporting that the presence information about the client 41 is managed by the in-site server 40 (S1607).

The default server 10, when receiving this presentity information notification, registers the URI of the presentity 41 and the address of the in-site server 40 as the presence server in an in-site presence server information table (S1608). Thereafter, the default server 10 sends a response showing “the registration being already done” to the in-site server 40 (S1609).

The in-site server 40 receives this response and registers the information about this default server 10 and the information about the presentity 41 in the default presence server information table (S1610).

Next, an operation in the case of transmitting the SUBSCRIBE to the presentity 41 from a watcher 23 in a site different from that of the presentity 41 after the information on the presentity 41 has been registered in the in-site server 40 and in the default server 10 as described above, will be explained with reference to FIG. 17. FIG. 17 is a sequence diagram showing an operational example of redirecting the SUBSCRIBE in the second embodiment.

When the client 23 in the site 2 requests the presence information of the client 41 in the site 4, the client (watcher) 23 transmits the SUBSCRIBE about the client (presentity) 41 to the default server 10 (S1711).

The default server 10, upon receiving the SUBSCRIBE, checks whether or not the information on the target presentity 41 is set in the in-site presence server information table (S1712). The default server 10, when judging that this information is set therein, acquires the address of the in-site server 40 with respect to the presentity 41 that is set in the in-site presence server information table, and sends a message containing this address to the watcher 23 (S1713).

The watcher 23, when receiving the redirection of the SUBSCRIBE (S1711) transmitted earlier (S1713), resends the SUBSCRIBE to the in-site server 40 that is contained in this message (S1715).

With this operation, the in-site server 40 accepts the SUBSCRIBE related to the presentity 41, then updates the presence information table (S1216), and makes a response showing this purport (S1718). The watcher 23 is thereby able to hereafter receive the presence information of the presentity 41 from the in-site server 40.

### Operation and Effect in Second Embodiment

Described herein are an operation and an effect of the presence information management system in the second embodiment discussed above.

In the presence information management system according to the second embodiment, each of the in-site presence servers previously has the presence server function. Each in-site server operates, e.g., as the presence server in regard to the presentity in the same site.

The client 41 becoming the presentity, on the occasion of starting providing the presence information, sends the registration request for using the presence service to the in-site server 40 managing the client 41 itself. In the in-site server 40 receiving this registration request for using the presence service, the presence information of this presentity 41 is hereinafter managed.

With this management, the presentity previously retains the information showing which server the presence server managing the presence information of the presentity itself corresponds to, and, if the registration request for using the presence service is sent to the predetermined presence server on the basis of this retained information, the presence server can start executing the presence server function related to this presentity as it is triggered by the registration request for using the presence service.

Accordingly, the same effect as in the first embodiment can be obtained without delegating the presence server function.

Moreover, the in-site server 40 receiving the registration request for using the presence service notifies, the default server 10 of the purport that the presence information of the presentity as the sender of this registration request for using the presence service is managed by the in-site server 40 itself.

With this operation, in the same way as in the first embodiment, even the watcher knowing none of the location of the presence server for each presentity can recognize the information about the presence server for the presentity by receiving the redirection of the SUBSCRIBE from the default server.

### Third Embodiment

The presence information management system in a third embodiment of the present invention discussed above will hereinafter be described. In the presence information management system according to each of the first embodiment and the second embodiment explained earlier, the in-site server, to which the presence server function is delegated or previously having the presence server function, transmits (NOTIFY) the presence information about the function-delegated presentity to each of the watchers.

The presence information management system in the third embodiment is a system having a new function added to the presence information management system in the second embodiment. This additional function is a function enabling batchwise transmission when the in-site server having the presence server function transmits the NOTIFY (message) to the plurality of watchers in other sites.

[Configuration of Device]

The additional function in the third embodiment will hereinafter be explained. This additional function does not limit the system architecture. The following description, on the occasion of actualizing this additional function, shall deal with the function that should be added to each device in the first embodiment and the second embodiment.

<Default Presence Server>

The default server 10 has no necessity of having any special function in order to actualize the additional function in the third embodiment. To give an item concerning the additional function, also in such a case that a representative SUBSCRIBE or an extended SUBSCRIBE, which will be described later on, is transmitted, in the same way as the case where the normal SUBSCRIBE is transmitted, the SUBSCRIBE is redirected if the redirection thereof is judged to be required.

<In-Site Presence Server>

It is required that the in-site server in the third embodiment be considered distinctively in the case of managing the presence information to be provided to the plurality of watchers in the same site (a case of operating as a watcher accommodating server) and in the case of managing the presence information of the presentity (a case of operating as a presentity accommodating server). The in-site server in each of the first embodiment and the second embodiment is related to the presentity accommodating server in these types. The in-site server in the third embodiment has the function related to the presentity accommodating server in each of the first embodiment and the second embodiment and also a newly-added function related to the watcher accommodating server.

For instance, in the system architecture shown in FIG. 1, if the clients 41, 42 are the watchers requesting the presence information of the presentity 21, the in-site server 40 operates as the watcher accommodating server, while the in-site server 20 operates as the presentity accommodating server. On the other hand, if the clients 21, 22, 23 are the watchers requesting the presence information of the presentity 41, the in-site server 40 operates as the presentity accommodating server, while the in-site server 20 operates as the watcher accommodating server. Note that the function related to the presentity accommodating server is as explained in the first embodiment and the second embodiment, so that its explanation is herein omitted. The function related to the watcher accommodating server for actualizing the additional function in the third embodiment will hereinafter be described.

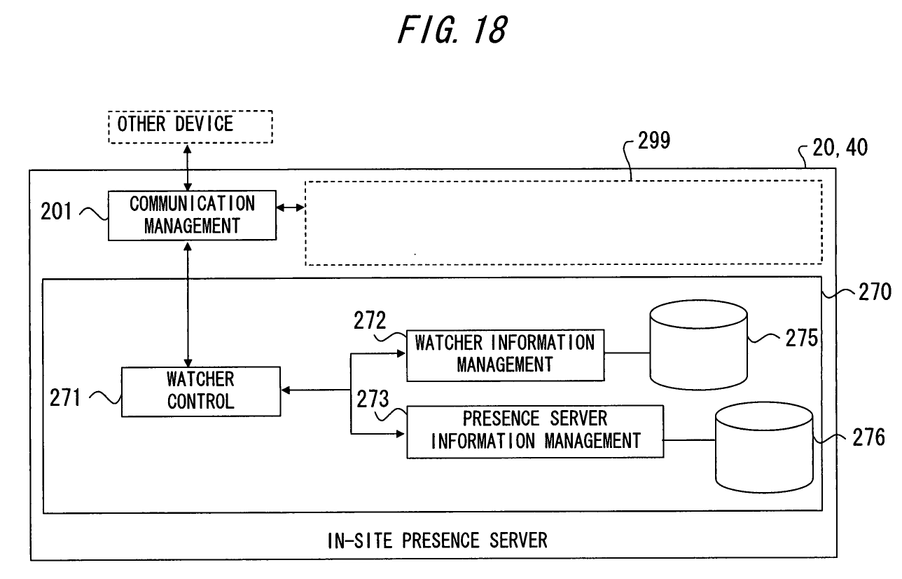

FIG. 18 is a block diagram showing a functional configuration of the in-site presence server in the third embodiment. The in-site server in the third embodiment is constructed of the communication management unit 201 (corresponding to request receiving unit according to the present invention), a presentity accommodating server function unit 299 and a watcher accommodating server function unit 270 (corresponding to transferring unit and transmitting unit according to the present invention). The presentity accommodating server function unit 299 has the same function as the function of the in-site server in the first embodiment and the second embodiment, and is therefore omitted in FIG. 18. The communication management unit 201 further has a function of allocating the messages received from other devices into those related to the presentity accommodating server function unit 299 and those related to the watcher accommodating server function unit 270.

The watcher accommodating server function unit 270 will hereinafter be explained. The watcher accommodating server function unit 270 includes a watcher control unit 271, a watcher information management unit 272, a presence server information management unit 273, a watcher information management database (DB) 275, a presence server information management database (DB) 276 and so forth.

<<Watcher Control Unit>>

The watcher control unit 271, in order to manage the presence information provided to the clients (watchers) within the same site, controls the watcher information management unit 272 and the presence server information management unit 273. The functions actualized by the watcher control unit 271 are a function (function 1) of transmitting the representative SUBSCRIBE, a function (function 2) of transmitting the extended SUBSCRIBE, and a function (function 3) of notifying, when receiving a batchwise NOTIFY to a representative URI from the presence server, plural target watchers of the NOTIFY.

As the (function 1), the watcher control unit 271, upon receiving the SUBSCRIBE from the watcher in the same site, transfers the information on the target presentity and the information on the watcher as the SUBSCRIBE sender to the watcher information management unit 272. Then, the watcher control unit 271 receives a representative URI associated with the SUBSCRIBE from the watcher information management unit 272, and further receives the address information of the presence server for the target presentity from the presence server information management unit 273. The watcher control unit 271 instructs, based on these items of information, the communication management unit 201 to transmit the representative SUBSCRIBE containing the representative URI to the presence server for the target presentity.

The representative SUBSCRIBE is distinguished from the normal SUBSCRIBE. The distinction therebetween may be made based on message type information and may also be made based on pieces of information contained in these messages. The representative SUBSCRIBE, unlike the normal SUBSCRIBE, contains representative URI.

Further, the watcher control unit 271, for actualizing the (function 2), when receiving the SUBSCRIBE related to the same presentity as with respect to the already-transmitted representative SUBSCRIBE from the watcher in the same site, instructs the communication management unit 201 to transmit the extended SUBSCRIBE containing the sender watcher URI and the representative URI to the presence server. At this time, the watcher control unit 271 makes the watcher information management unit 272 judge whether or not the received SUBSCRIBE is related to the same presentity as of the representative SUBSCRIBE transmitted earlier, and acquires the information about the presence server for this presentity from the presence server information management unit 273.

This extended SUBSCRIBE is distinguished from the normal SUBSCRIBE and from the representative SUBSCRIBE. The extended SUBSCRIBE contains the sender watcher URI. Note that the extended SUBSCRIBE and the representative SUBSCRIBE may each be organized as the same message. In this case, both of messages may each contain the representative URI and the sender watcher URI.

Further, the watcher control unit 271, if there is a response of rejecting the representative SUBSCRIBE and the extended SUBSCRIBE, transfers this purport to the watcher information management unit 272. With this transfer, the watcher information management unit 272 operates so that the NOTIFY is not transmitted to the rejected watcher.

Moreover, for actualizing the (function 3), the watcher control unit 271, in the case of receiving the NOTIFY addressed to the representative URI from the presence server, instructs the communication management unit 201 to send the NOTIFY to all of the watchers requesting this NOTIFY in the same site. At this time, the watcher control unit 271 acquires, from the watcher information management unit 272, the information about all of the watchers which should transmit the NOTIFY.

<<Watcher Information Management Unit>>

The watcher information management unit 272 manages the information (URI) about the received SUBSCRIBE target presentity and the information (URI) about the SUBSCRIBE sender watcher, that are transferred from the watcher control unit 271 as described above. These items of information are retained in the watcher information management DB 275.

Further, the watcher information management unit 272, when receiving the information described above from the watcher control unit 271, generates the representative URI for aggregating the watchers in the same site, which execute the SUBSCRIBE to the same presentity. The representative URI is independently generated, wherein, for example, domain part is set as a domain address of the self-device, and another part is set as a unique ID. The watcher information management unit 272, in the case of receiving the SUBSCRIBE concerning the presentity unregistered in the watcher information management DB 275, generates the representative URI. This representative URI is also retained in the watcher information management DB 275.

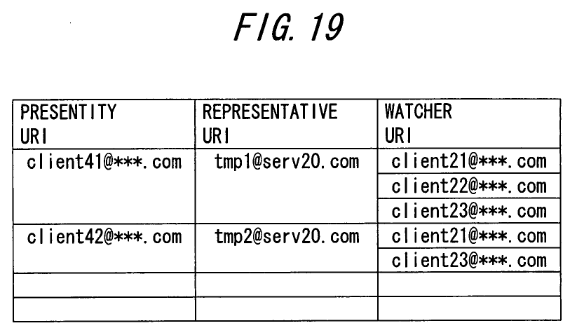

FIG. 19 is a diagram showing a watcher information table within the watcher information management DB 275. Registered in the watcher information table are, with respect to every presentity, a list of the watcher URIs and the representative URIs. In the example shown in FIG. 19, the clients 21, 22, 23 (client21@***.com, client22@***.com, client23@***.com) are registered as the watchers executing the SUBSCRIBE to the presentity 41 (URI is client41@***.com), and the representative URI (tmp1@serv20.com) for aggregating these watchers is also registered. For instance, [serv20.com] in this representative URI represents the domain address of the in-site server 20, and [tmp1] may be set as an ID that is automatically generated.

The watcher information management unit 272, in the case of receiving SUBSCRIBE about the presentity already registered in the watcher information table, adds this sender watcher to the watcher information table, and returns the representative URI generated in regard to this watcher to the watcher control unit 271.

Further, the watcher information management unit 272, if a rejection response to the transmitted representative SUBSCRIBE and the transmitted extended SUBSCRIBE is given from the presence server, deletes the information about this watcher from the list in the watcher information table.

<<Presence Server Information Management Unit>>

The presence server information management unit 273 manages the presence server related to each presentity. This information is retained in the presence server information management DB 276. Note that the presence server information table within this presence server information management DB 276 retains the information on every presence server with respect to each presentity.

<Client (Watcher and Presentity)>

The client has no necessity of having any special function in order to actualize the additional function in the third embodiment. To give an item concerning the present additional function, the client in the third embodiment, in the case of operating as the watcher, has a necessity of retaining the address of the in-site server operating as the watcher accommodating server for the self-device. The client transmits the SUBSCRIBE to the in-site server to be retained.

### OPERATIONAL EXAMPLE

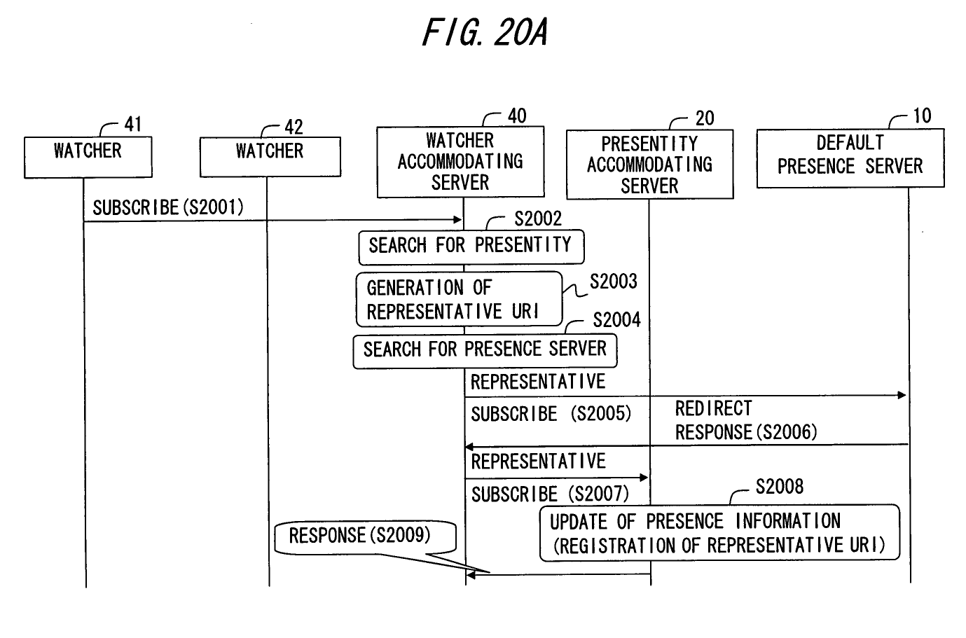

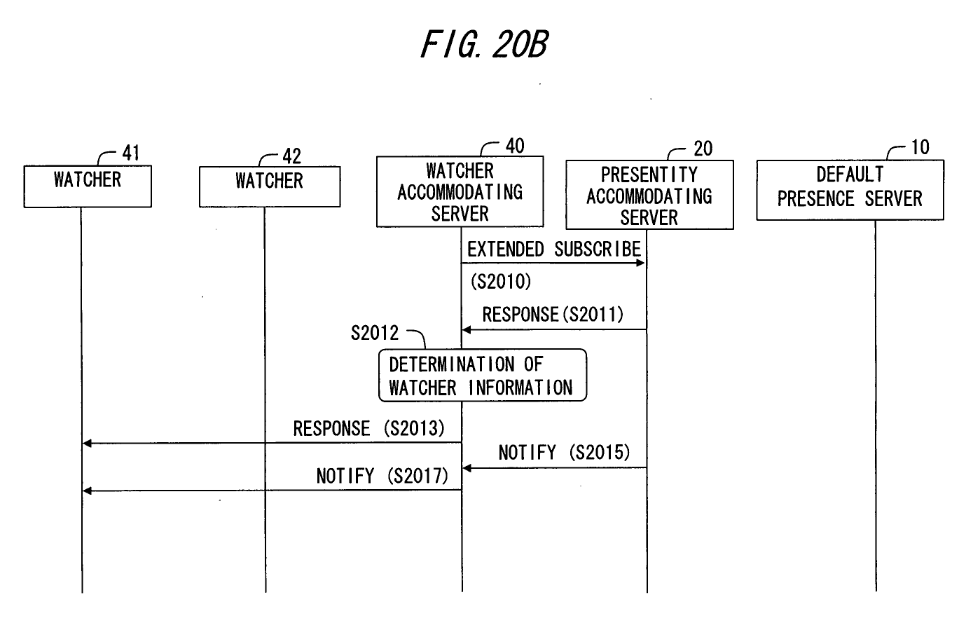

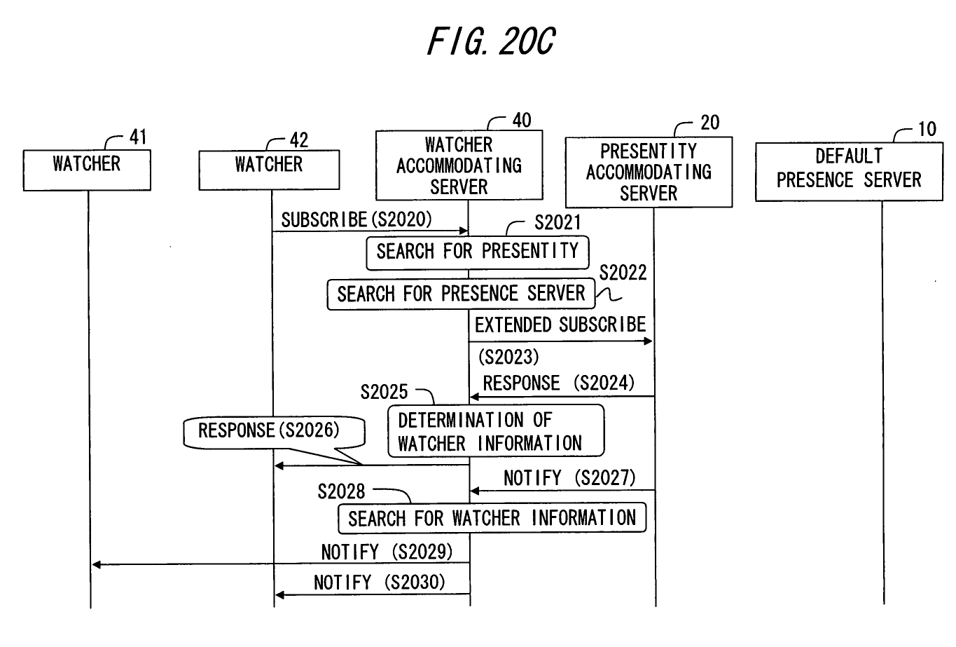

An operational example of the presence information management system in the third embodiment will hereinafter be described with reference to FIGS. 20A, 20B and 20C. FIGS. 20A, 20B and 20C are sequence diagrams showing the operational example when executing the SUBSCRIBE in the presence information management system in the third embodiment. FIGS. 20A, 20B and 20C illustrate the operational example in such a case that the clients 41, 42 are the watchers requesting the presence information of the client 21 in the system architecture shown in FIG. 1. In this case, the in-site server 40 operates as the watcher accommodating server for the watchers 41, 42, while the in-site server 20 operates as the presentity accommodating server for the presentity 21.

The watcher 41 acquires, from the database etc, the address information of the in-site server 40 operating as the watcher accommodating server for the self-device, and transmits the SUBSCRIBE related to the presentity 21 to the in-site server (the watcher accommodating server) 40 (S2001).

The watcher accommodating server 40, upon receiving this SUBSCRIBE, searches the watcher information table for the information on the SUBSCRIBE target presentity 21 (S2002). The watcher accommodating server 40, when judging that the information on the presentity 21 does not exist, adds a record of this presentity 21 to the watcher information table, and, along with this, generates the representative URI associated with this presentity 21 (S2003). The URI of this presentity 21, the URI of the watcher 41 and the representative URI are each registered in the watcher information table.

The watcher accommodating server 40 acquires the address information of the presence server for the presentity 21 from the presence server information table (S2004). Herein, an assumption is that the address information of the default server 10 as the presence server for the presentity 21 be acquired. The watcher accommodating server 40 sends the representative SUBSCRIBE containing the representative URI to the default server 10 (S2005).

The default server 10, when receiving the representative SUBSCRIBE, by dint of the functions in the first embodiment and the second embodiment, detects that the presence server for the target presentity 21 is the in-site server 20. The default server 10 sends the redirect response showing this purport to the watcher accommodating server 40 as the sender thereof (S2006).

The watcher accommodating server 40, upon receiving this redirect response, updates the presence server information related to the presentity 21 in the presence server information table. Namely, the in-site server 20 is registered as the presence server for the presentity 21. Subsequently, the watcher accommodating server 40 transmits the representative SUBSCRIBE to the in-site server (the presentity accommodating server) 20 (S2007).

The presentity accommodating server 20, when receiving this SUBSCRIBE, registers the representative URI as the watcher concerning the presentity 21 in the presence information table (S2008). The presentity accommodating server 20 sends a response, purporting that the registration is completed, to the watcher accommodating server 40 as the sender of the representative SUBSCRIBE (S2009).

The watcher accommodating server 40, when receiving this response, transmits the extended SUBSCRIBE containing the URI of the watcher 41 as the sender of this SUBSCRIBE (S2010).

The presentity accommodating server 20, upon receiving this extended SUBSCRIBE, checks whether or not the watcher 41 is a watcher valid for being provided with the presence information of the presentity 21. For example, the presentity accommodating server 20 checks whether or not the presentity 21 permits the watcher 41 to be provided with the presence information. The presentity accommodating server 20, when judging that the watcher 41 is the watcher valid for being provided with the presence information, sends a response (e.g., 200OK) showing this purport to the watcher accommodating server 40 as the sender of the extended SUBSCRIBE (S2011).

The watcher accommodating server 40, when receiving the response showing the purport that the watcher is valid for being provided with the presence information, determines a record of the presentity 21 in the watcher information table (S2012). On the other hand, the watcher accommodating server 40, in the case of receiving the response purporting the rejection of being provided with the presence information, deletes the information of the watcher 41 related to the presentity 21 that is previously registered in the watcher information table (S2012). The watcher accommodating server 40 sends any one of these responses to the watcher 41 (S2013).

In this status, the URI of the watcher 41 is registered in the record of the presentity 21 in the watcher information table of the watcher accommodating server 40. In this case, the presentity accommodating server 20, when receiving the presence information changing notification from the presentity 21, sends the NOTIFY to the representative URI registered as the watcher in the presence information table (S2015).

The watcher accommodating server 40, when receiving the NOTIFY to this representative URI, acquiring the list of the watchers to which the NOTIFY should be transmitted in a way that searches the watcher information table. Herein, the watcher accommodating server 40 obtains the URI of the watcher 41. Based on this URI, the watcher accommodating server 40 transfers the NOTIFY to this watcher 41 (S2017).

Subsequently, the watcher 42 sends the SUBSCRIBE related to the presentity 21 to the watcher accommodating server 40 (S2020).

The watcher accommodating server 40, upon receiving this SUBSCRIBE, retrieves the information on the SUBSCRIBE target presentity 21 from the watcher information table (S2021). The watcher accommodating server 40, when judging that the information on the presentity 21 has already been registered, registers the URI of the watcher 42 in the record of the presentity 21 in the watcher information table.

The watcher accommodating server 40 acquires the address information of the presence server for this presentity 21 from the presence server information table (S2022). Herein, the address information of the in-site server 20 has already been registered as the presence server for the presentity 21 in the presence server information table, and hence the watcher accommodating server 40 acquires the address of this in-site server 20.

The watcher accommodating server 40, because of the representative URI associated with the presentity 21 being already registered, sends the extended SUBSCRIBE containing the URI of the watcher 42 to the presentity accommodating server 20 (S2023).

The presentity accommodating server 20, upon receiving this extended SUBSCRIBE, checks whether or not the watcher 42 is a watcher valid for being provided with the presence information of the presentity 21. For example, the presentity accommodating server 20 checks whether or not the presentity 21 permits the watcher 41 to be provided with the presence information. The presentity accommodating server 20, when judging that the watcher 41 is the watcher valid for being provided with the presence information, sends a response (e.g., 200OK) showing this purport to the watcher accommodating server 40 as the sender of the extended SUBSCRIBE (S2024).

The watcher accommodating server 40, when receiving the response showing the purport that the watcher is valid for being provided with the presence information, determines the information of the watcher 42 related to the presentity 21 in the watcher information table (S2025). On the other hand, the watcher accommodating server 40, in the case of receiving the response purporting the rejection of being provided with the presence information, deletes the information of the watcher 42 related to the presentity 21 that is previously registered in the watcher information table (S2025). The watcher accommodating server 40 sends any one of these responses to the watcher 42 (S2026).

In this status, the URIs of the watchers 41 and 42 are registered in the record of the presentity 21 in the watcher information table of the watcher accommodating server 40. In this case, the presentity accommodating server 20, when receiving the presence information changing notification from the presentity 21, sends the NOTIFY to the representative URI registered as the watcher in the presence information table (S2027).

The watcher accommodating server 40, when receiving the NOTIFY to this representative URI, acquiring the list of the watchers to which the NOTIFY should be transmitted in a way that searches the watcher information table (S2028). Herein, the watcher accommodating server 40 obtains the URIs of the watchers 41 and 42. Based on these URIs, the watcher accommodating server 40 transfers the NOTIFY to these watchers 41 and 42 (S2029, S2030).

### Operation and Effect in Third Embodiment

Herein, an operation and an effect of the presence information management system in the third embodiment discussed above will be described.

In the presence information management system in the third embodiment, when receiving the SUBSCRIBE concerning the same presentity from the watchers accommodated by the watcher accommodating server, the representative SUBSCRIBE containing the representative URI associated with these watchers is sent to the default server or to the presentity accommodating server (the presence server).

In the presence server receiving this representative SUBSCRIBE, hereafter, when receiving the presence information changing notification from this representative SUBSCRIBE target presentity, the NOTIFY containing the representative URI thereof is sent (NOTIFied batchwise) to the watcher accommodating server.

In the watcher accommodating server receiving this batchwise NOTIFY, the list of watchers associated with this representative URI is retained, and the NOTIFY is transmitted to each of the actual requester watchers contained in this watcher list.

With this operation, the number of NOTIFY messages between the presence server and the watcher accommodating server can be reduced. Further, this NOTIFY is the message transmitted in response to the presence information changing notification given from the presentity of which the presence information was changed, and therefore the watcher can know the change in the presence information in realtime.

### OTHERS

The disclosures of Japanese patent application No. JP2006-209438, filed on Aug. 1, 2006 including the specification, drawings and abstract are incorporated herein by reference.

What is claimed is:

1. A presence server device managing presence information of a plurality of presentities, comprising:
a delegating unit sending delegating notification of presence information management function related to at least one of the plurality of presentities, to another device becoming a delegatee of the presence information management function.

2. A presence server device according to claim 1, further comprising:
a retaining unit retaining, with respect to every presentity, information about a watcher requesting presence disclosure and a delegating condition; and
a determining unit determining, based on the information retained by the retaining unit, the presentity for which the presence information management function is delegated and the another device becoming the delegatee.

3. A presence server device according to claim 1, further comprising:
a delegatee retaining unit retaining the information about the presentity for which the presence information management function is delegated and the information about the another device becoming the delegatee; and
a transmitting unit transmitting, when receiving a presence disclosure request related to the presentity for which the presence information management function is delegated, the information about the another device becoming the delegatee to the watcher sending the presence disclosure request based on the information retained by the delegatee retaining unit.

4. A gateway device comprising:
a managing unit managing presence information of a presentity; and
a control unit performing control so that, when receiving delegating notification of presence information management function about at least one of a plurality of presentities from a presence server managing the presence information of the plurality of presentities,
wherein the managing unit is executed with respect to the function-delegated presentity for which the presence information management function is delegated.

5. A gateway device according to claim 4, further comprising
a notifying unit notifying, when receiving delegating notification of the presence information management function, the function-delegated presentity and a watcher requesting the presence disclosure with respect to the function-delegated presentity of a purport that the presence information management function is delegated to the gateway device itself.

6. A gateway device according to claim 4, further comprising:
a storage unit storing information about the watcher requesting the presence disclosure and a delegating condition with respect to the function-delegated presentity; and
a delegation determining unit determining, based on the information stored by the storage unit, the presentity for which the delegated presence information management function should be further delegated and another gateway device or the presence server becoming a next delegatee.

7. A client device providing presence information of a self-device, comprising:
a change notifying unit transmitting, when receiving notification purporting that a server function of managing the presence information provided from the client device itself is delegated, presence information changing notification to a device to which the server function is delegated.

8. A client device provided with presence information of another client device, comprising:
a notification receiving unit receiving, when receiving notification purporting that a server function of managing presence information of a client device being requested by the self-device is delegated, presence notification of the client device being requested by the client device itself from a delegatee device to which the server function is delegated.

9. A presence information management system including a first presence server and a second presence server managing presence information of a presentity so as not to be overlapped with each other,
the presentity comprising:
a request transmitting unit transmitting, when starting providing presence information of the presentity itself, a registration request for using presence service to the second presence server that should manage the presence information of the presentity itself,
the second presence server comprising:
a managing unit starting, when receiving the registration request for using the presence service, management of the presence information of the presentity becoming a sender of the registration request; and
a start notifying unit notifying the first presence server that the second presence server itself starts the management of the presence information of the presentity,
the first presence server comprising:
a retaining unit retaining information showing that the second presence server starts the management of the presence information of the presentity.

10. A presence information management system according to claim 9, wherein the presentity further comprises a notifying unit transmitting, after transmitting the registration request for using the presence service and if the presence information of the presentity itself is changed, presence information changing notification to the second presence server.

11. A presence information management system according to claim 9, wherein the first presence server further comprises a notifying unit notifying, when receiving a presence disclosure request about the presentity retained by the retaining unit, a watcher, as a sender of the presence disclosure request, of information about the second presence server managing the presence information of the presentity retained by the retaining unit.

12. A gateway device comprising:
a request receiving unit receiving a plurality of presence disclosure requests with respect to the same presentity from a plurality of watchers;
a transferring unit transferring, to a presence server, at least one of the plurality of presence disclosure requests received by the request receiving unit as a presence disclosure request from a virtual watcher associated with the plurality of watchers; and
a transmitting unit transmitting, when receiving presence information changing notification to the virtual watcher, the received presence information changing notification respectively to the plurality of watchers associated with the virtual watcher.

13. A gateway device according to claim 12, the transferring unit including:
a list retaining unit retaining a list of the plurality of watchers associated with the virtual watcher; and
a pseudo requesting unit transmitting, respectively to the presence server, each of the plurality of presence disclosure requests received by the request receiving unit as a pseudo presence disclosure request containing the information about the watcher as a sender, and
the transmitting unit including:
a deleting unit deleting, in the case of obtaining a response of rejecting the pseudo presence disclosure request from the presence server, the watcher as the sender contained in the pseudo presence disclosure request from the list of the plurality of watchers retained by the list retaining unit,
wherein the transmitting unit transmits the received presence information changing notification to the watchers in the list retained by the list retaining unit.

14. A presence server device comprising:
a receiving unit receiving a presence disclosure request from a virtual watcher with respect to a predetermined presentity; and
a transmitting unit transmitting, when receiving presence information changing notification from the predetermined presentity, the received presence information changing notification to the virtual watcher.

15. A presence server device according to claim 14, further comprising:
a retaining unit retaining, with respect to the presence disclosure request received by the receiving unit, information about the target presentity and information about the virtual watcher as a requester;
a judging unit judging, when receiving a pseudo presence disclosure request about the presentity retained by the retaining unit, the retaining unit retaining none of an watcher as an actual requester associated with the virtual watcher contained in the pseudo presence disclosure request, whether or not the watcher as the actual requester is a watcher valid for receiving the disclosure of the presence information; and
a responding unit responding a judged result to a sender of the pseudo presence disclosure request.
